(19) United States
(12) Patent Application Publication
(10) Pub. No.: US 2024/0082804 A1
(43) Pub. Date: Mar. 14, 2024

(54) Methods For Producing Seed And Transformation Of Seeds Into Hollow Structures

(71) Applicant: Plassein Technologies Ltd. LLC, Las Vegas, NV (US)

(72) Inventor: David Charles Lynch, Kingsport, TN (US)

(21) Appl. No.: 18/234,856

(22) Filed: Aug. 16, 2023

Related U.S. Application Data
(60) Provisional application No. 63/398,393, filed on Aug. 16, 2022.

(51) Int. Cl. B01J 13/02

(52) U.S. Cl. CPC B01J 13/02

(57) ABSTRACT

An example method for producing a seed capable of transforming into a hollow structure includes providing a core, forming a coating around the core to create a coated core, forming an exterior layer surrounding the coated core, forming a layer of release agent surrounding the exterior layer, and heating the core, the coating and the exterior layer. Heating the core, the coating, and the exterior layer to a particular temperature transforms the exterior layer to a fixed shell and produces a seed with the coated core surrounded by the fixed shell. The particular temperature is sufficient to fuse or sinter the exterior layer, but too low to fuse the coating, and too low to cause the core to generate a gas.

### RELATED APPLICATIONS

This application claims the benefit of copending U.S. Provisional Patent Application No. 63/398,393, filed on Aug. 16, 2022 by the same inventor, which is incorporated herein by reference in its entirety.

### BACKGROUND OF THE INVENTION

### Field of the Invention

This invention relates to the production of hollow spheres, and more particularly to methods for producing seeds and transformation of the seeds into hollow structures that can with stand operational temperatures up to 2,000° C. Structure and structures include any of the following: hollow spheres, a honeycomb like form consisting of hollow and sealed cells, forms consisting of close packed hollow spheres, forms consisting of non-close packed hollow spheres, forms consisting of one or more size of hollow spheres, and forms consisting of non-spherical hollow cells of both uniform and non-uniform sizes. A seed is a construct consisting of a core and a coating. Upon heating the core generates a gas either on its own or through chemical reaction with the coating. Simultaneously during heating the viscosity of the coating, consisting of a glass (or forms a glass), decreases so that the internal gas pressure created by the core can expand the coating, forming a hollow structure.

### Description of the Background Art

There are several sections in this review of the Background Art. They may seem as being unrelated, but each provides information as to the limits of competing technologies and technical information used in identifying new intellectual property.

### Hollow Spheres

Hollow spheres are sold by 4 companies, CenoStar, Petra, Potters, and 3M. CenoStar and Petra harvest hollow spheres from coal fired power plant waste. Those aluminosilicate spheres have a maximum operational temperature of approximately 1040° C. or below depending on composition. Petra, along with 3M, sell hollow spheres formed from soda-lime borosilicate glass with a maximum operational temperature of about 600° C. Potters sells hollow glass spheres but does not provide information as to the composition of the glass or indicate that the spheres can be used at any elevated temperature. Hollow spheres sold by CenoStar, Petra, and 3M have an internal gas pressure of 0.25 atmospheres or greater, a condition that impacts their thermal conductivity.

Methods for synthesizing hollow silica spheres have been a topic of research since 1968, gaining greater interest as the field of nanomaterials has advanced. In known methods for the synthesizing of hollow spheres, a preform is created and silica is deposited around the form by chemical processes. The interior preform is removed by either chemical reaction or firing at temperatures up to 500° C. The latter technique has proved more successful in retaining the hollow spherical shape. Scanning electron microscopy reveals that the wall structure of the hollow spheres consists of smaller spheres of silica. The micrographs also reveal that the wall of a sphere formed by such synthesis is porous. Formation of hollow spheres at low temperatures reduces their strength, and thus limits their use.

### Foamed Glass

Poraver produces “Expanded Glass” which is a foam formed by mixing particles of calcium carbonate in molten recycled glass and then heating that mixture to 900° C. to decompose the carbonate and thereby forming the foam. The maximum operational temperature for the foam is approximately 700° C. Lack of uniformity in the size and distribution of hollow spaces limits their structural use, and the presence of an internal gaseous environment of carbon dioxide at 0.25 atm impacts their thermal conductivity.

### Foamed Metal

There are two forms of metal foam, metal sponge and composite metal foam (CMF). The latter consists of aluminum cast around hollow steel balls. Metal sponge, is the most common form of metal foam primarily involving aluminum and large open cells produced by:
1. Casting molten metal around a form such as powdered salt that is later leached;
2. Adding thickeners (powdered ceramics) to raise viscosity of the metal and then blow gas through the mix as the metal solidifies; or
3. Hydride or mercury added as a gas generator to the metal as it begins to solidify. Production methods for Metal Sponge yields a lack of uniformity with open pores.

### Foamed Ceramic

Ceramic foam is produced by casting ceramic slip around a polymer form (usually beads). The beads are removed during an initial low temperature firing of the casting to burn off the polymer in the form and drive off moisture in the slip before sintering the ceramic powder.

### Aerogel

Aerogels are very expensive, very weak, and contain a gas that impacts their thermal conductivity.

### Oxidation of Silicon Carbide

In the oxidation of silicon carbide, a protective layer of silica is known to form at temperature below 1200° C., as O₂ molecules pass through the oxide layer to react with SiC forming a solid product of SiO₂. The physical character of the silica formed upon oxidation of SiC impacts the rate of oxidation.

S. Ramanathan et al. oxidized SiC in air at temperatures between 1202° C. to 1402° C. (S. Ramanathan, R. V. Muraleedharan, Ramprasad, and S. Banerjee, Oxidation Kinetics of Silicon Carbide Powder, Interceram, 14 (3), 1992, p. 157-159.) Ramanathan and coworkers periodically removed their SiC powdered samples from the tube furnace to weigh the specimen using an electronic balance. In Ramanathan's experiments at temperatures between 1202 to 1352° C. the rate of weight gain is typical of that expected for molecular diffusion of O₂ through interstitial sites in the silica layer as it becomes thicker with continued reaction. However, at 1402° C. the oxidation rate of the SiC powder initially follows that associated with molecular diffusion, but after one cycle (for SiC fine powder) and two cycles (for SiC coarse powder) the rate of reaction comes to a near stop. Here, the term “cycle” refers to removing the specimen, weighing it, and returning it to the furnace.

Ramanathan et al. suggest that the “abnormal behavior of oxidation at 1402° C. could be attributed to the mobility of the silica scale at this temperature, which resulted in a drastic reduction in the surface area of the” silica reaction product “due to fusion of the adjacent” silica particles. The authors provided micrographs that the authors believe provide evidence in support of their conclusion.

The inventor associated with this patent application interprets the results of Ramanathan, and coworkers as follows. They report that the silica product formed by the oxidation of SiC at 1352° C. was “fragile.” Given that air was used as the oxidizing agent, there would be a significant rate of O₂ arriving at the interface between silicon carbide and the silica product. At higher concentration of oxygen and higher temperatures more nuclei form per unit area at the interface for growth of quartz crystals. The growth of the nuclei soon impinges on each other bringing growth of the nuclei to a stop having produced, only, small crystals. Now oxygen diffuses through the thin layer of quartz crystals, but by a slower mechanism (solid-state diffusion), and at the SiC surface more nuclei form. The process continues forming a product consisting of small quartz crystals in the atomic structure of tridymite. Tridymite is stable at temperatures between 867 to 1470° C., whereas below 867° C. β-quartz is stable to 573° C., and below that temperature α-quartz is stable. Ramanathan in using SiC powder, the nuclei that formed were not aligned, such that complete bonding between the small quartz crystals did not occur. But, the formation of numerous nuclei produced small crystals that filled void spaces. At lower temperatures fewer nuclei form, and as a result larger quartz crystals form with unfilled void spaces.

Ramanathan and his coworkers claim that the SiO₂ product produced at 1352° C. was “fragile,” more likely it was friable due to the incomplete bonding, between the smaller quartz crystals. However, in taking each specimen out of the furnace and allowing it to cool brought about phase transformation; tridymite to β-quartz, and β-quartz to α-quartz. Upon reheating the specimen α-quartz was transformed to β-quartz, and β-quartz to tridymite. With small quartz crystals, with a high surface area at which there is unsatisfied bonding, the phase changes allow the surface atoms to realign allowing bonding between the small crystals. The smaller a crystal is, the more unstable it is, and the smaller crystals will preferentially combine with other crystals (atom by atom) to form a larger and more stable crystal. However, the temperature is not high enough to allow sufficient movement of the SiO₂ molecules in the two separate and nonaligned crystals to form a unified crystal with a single alignment of the crystal plains. The result, with the small crystals, is a phase with decreased void volume reducing the ability of O₂ to reach the SiC—SiO₂ interface. Structurally the silica product on a molecular scale will appear as fused silica, given the inability of small adjacent crystals to realign their crystal planes, surrounding small pockets of aligned molecules of SiO₂. Fused silica, a liquid, once formed, although not a stable phase at temperatures below 1713° C., is a pseudo-stable phase at lower temperatures due to its viscosity preventing realignment of the molecules. Thus, once formed it will retain the vitreous structure.

The reduction in void volume with the formation of fused silica isolates the SiC from further oxidation, limiting the arrival of oxygen at the interface between SiC and SiO₂ by transforming the movement of oxygen by molecular diffusion through interstitial sites to solid-state diffusion.

Costello and Tressler provide additional proof that the oxidized product changes structurally, impacting the diffusion of O₂. (J. A. Costello and R. E. Tressler, Oxidation Kinetics of Hot-Pressed and Sintered α-SiC, Journal of the American Ceramic Society, 64 (6), p 327-331.) They reacted hot-pressed and sintered SiC in air at temperatures between 1200° C. to 1500° C. They proved, using platinum markers that growth of the silica layer occurs at the interface between the SiC and SiO₂. They report, for both materials, at “the higher temperatures, parabolic behavior was exhibited for short times . . . . [f]ollowed by decrease in rates at longer times.” Parabolic behavior is typical of molecular diffusion control of the oxidation reaction of particulate. Costello and Tressler reported problems in some experiments for “the hot-pressed material, the rate at long times appears to increase at higher temperatures. Bubbles, as well as craters, which formed from the burst bubbles, were present on the samples oxidized at the higher temperatures, suggesting that rupturing of the oxide film by the escape of gaseous by-products may cause the increase.” The author of this report believes carbon-rich SiC produced CO(g) that produced the rupture of the SiO₂ product layer. Costello and Tressler also found that the activation energies “varied with temperature, from 134 to 389 kJ/mol for the sintered alpha material and from 155 to 498 kJ/mol for the hot-pressed variety.” The lower activation energy is that associated with molecular diffusion, while the larger numbers at higher temperatures suggest that a slower mechanism for transport of oxygen becomes rate controlling. The higher activation energy is an indication of the diffusion process shifting from a molecular process that utilizes interstitial voids in the glass to solid-state diffusion where oxygen ions jump from covalent bonded silicon to another silicon atom. The process relies on the movement of unoccupied covalent sites.

Costello and Tressler believe the change in mechanism for the oxidation of SiC involves the formation of a crystalline phase. They report that “with a densification aid, cristobalite and mullite were detected in samples oxidized at 1300° C.” and not in specimens oxidized at 1200° C.

Zheng, Tressler, and Spear report on the oxidation of single-crystals of silicon carbide at temperatures between 1200 to 1500° C. (Z. Zheng, R. E. Tressler, and K. E. Spear, Oxidation of Single-Crystal Silicon Carbide, Part I Experimental Studies, J. Electrochem. Soc., 137 (3), March 1990, p. 854-858) They found that below 1350° C. that the activation energy “was approximately 120 kJ/mol . . . and 260 kJ/mol above 1350° C.” for the 0001-crystal face. They report that with “[d]ouble oxidation experiments using ¹⁶O₂ and ¹⁸O₂ indicated that the process is dominated by the transport of molecular oxygen at lower temperatures (<1300° C.) with a substitutional contribution from diffusion of ionic oxygen at higher temperatures.” Stated differently molecular diffusion at lower temperatures gives way to slower solid-state diffusion at higher temperatures.

The work of Ramanathan et al., Castello and Tressler, and Zheng and co-workers demonstrate that structural changes in the silica product layer can significantly alter the rate of diffusion of O₂. While the discussion has been limited to the diffusion of oxygen, the structural changes are expected to impact the diffusion of other gases.

### SUMMARY

Improved methods and chemistries are provided for producing seeds capable of transforming into hollow structures and for transforming the seeds into hollow structures. An example method for producing a seed capable of transforming into a hollow structure includes providing a core, forming a coating around the core to create a coated core, forming an exterior layer surrounding the coated core, forming a layer of release agent surrounding the exterior layer, and heating the core, the coating and the exterior layer. The core can have a particular composition that reacts to generate a gas when heated to a first predetermined temperature. The coating can have a particular composition that will fuse to form a continuous shell surrounding the core when the coating is heated to a second predetermined temperature. Forming the exterior layer of material surrounding the coated core produces an encased coated core. The material of the exterior layer can have a fusion temperature such that the exterior layer of material fuses or sinters below a third predetermined temperature. The layer of release agent surrounds the encased coated core. Heating the core, the coating, and the exterior layer to a fourth temperature transforms the exterior layer to a fixed shell and produces a seed with the coated core surrounded by the fixed shell. The fourth temperature is greater than or equal to the third predetermined temperature. The fourth temperature is also less than the first predetermined temperature, and the fourth temperature is less than the second predetermined temperature. The example method can additionally include mechanically separating the seed from the release agent and from other seeds produced with the seed.

In a particular example method, the core, the coating, the exterior layer, and the release agent are all positioned relative to one another by a printing process prior to the heating the core, the coating, and the exterior layer to the fourth temperature.

In another example method, the step of providing the core can include providing a plurality of cores arranged in a single layer. The step of forming a coating around the core can include forming coatings around each core of the plurality of cores to produce a layer of coated cores. The step of forming an exterior layer of material surrounding the coating can include forming an exterior layer of the material surrounding each coated core of the layer of coated cores to form a layer of encased coated cores. The step of forming a layer of release agent surrounding the external layer of material can include forming a layer of release agent separating the encased coated cores from one another.

The example method can additionally include forming multiple layers of encased coated cores separated by release agent prior to heating the core, the coating, and the exterior layer to the fourth temperature. The cores of each layer can be arranged in a same lattice structure. Optionally, the lattice structure of each layer can be offset with respect to the lattice structures adjacent layers. In a particular example, the lattice structure can be hexagonal.

Example methods can additionally include forming an inner layer of the material between the core and the coating and forming girders of the material. The girders can extend from the inner layer of the material, through the coating, to the exterior layer of the material.

In example methods, the step of forming a coating around the core can include the use of an adhesive. After applying an adhesive to the core, the core with the adhesive applied thereon can be brought into contact with the coating material. The step of applying the adhesive to the core can include dropping the core through a cloud of the adhesive. The step of bringing the core with the adhesive applied thereon into contact with the coating material can include dropping the core with the adhesive applied thereon through a cloud of the coating material. The step of dropping the core through the cloud of the adhesive can include applying a positive electrical charge to one of the core and the adhesive, and applying a negative electrical charge to the other of the core and the adhesive. The step of dropping the core with the adhesive applied thereon through a cloud of the coating material can include applying a positive electrical charge to one of the adhesive and the coating material, and applying a negative electrical charge to the other of the adhesive and the coating material.

In example methods, the core can include silicon alloyed with an element that reduces the activity of silicon. Alternatively, the core can include silicon mixed with an element that alloys with silicon upon heating and reduces the activity of silicon. In a particular example method, the core includes silicon and at least one of iron and nickel.

An example method for forming seeds, capable of transforming into hollow structures, in a tray is also disclosed. The example method includes providing a tray having a bottom surface and depositing a first layer of release agent on the bottom surface of the tray. The example method additionally includes depositing a first layer of outer shell material on the layer of release agent. The first layer of the outer shell material can be patterned in an array of discrete spaced apart shapes. The example method additionally includes depositing a first layer of coating material on the first layer of outer shell material. The first layer of coating material can be patterned in an array of discrete spaced apart shapes. Each of the discrete spaced apart shapes of the coating material can be disposed on an associated one of the discrete spaced apart shapes of the outer shell material. The example method additionally includes depositing a layer of seed material on the first layer of the coating material. The layer of seed material can be patterned in an array of discrete spaced apart shapes. Each of the discrete spaced apart shapes of the seed material can be disposed on an associated one of the discrete spaced apart shapes of the coating material. The example method additionally includes depositing a second layer of coating material over the first layer of coating material and over the seed material. The second layer of coating material can be patterned in an array of discrete spaced apart shapes. Each discrete spaced apart shape of the second layer of coating material can contact an associated one of the discrete spaced apart shapes of the first layer of coating material, with an associated one of the discrete spaced apart shapes of the seed material disposed therebetween. The example method additionally includes depositing a second layer of the outer shell material over the second layer of the core material. The second layer of the core material can be patterned in an array of discrete spaced apart shapes. Each discrete spaced apart shape of the second layer of the core material can be disposed over an associated one of the discrete spaced apart shapes of the second layer of the coating material, and can be in contact with the first layer of the outer shell material. The example method additionally includes depositing a second layer of the release agent over the second layer of outer shell material. The second layer of the release agent can be in contact with the first layer of the release agent between the discrete spaced apart shapes of the first layer of the outer shell material. Optionally, the first layer of the outer shell material, the first layer of the coating material, the layer of core material, the second layer of the coating material, and the second layer of the outer shell material can be deposited simultaneously via a 3-dimensional printing process.

In a particular example method, the core material can have a particular composition that reacts to generate a gas when heated to a first predetermined temperature. The coating material can have a particular composition that will fuse to form a shell around the core when the coating material is heated to a second predetermined temperature. The outer shell material can have a fusion temperature such that the outer shell material will fuse or sinter below a third predetermined temperature. A fourth temperature is less than the first predetermined temperature. Also, the fourth temperature is less than the second predetermined temperature, and the fourth temperature is greater than or equal to the third predetermined temperature. The particular example method additionally includes heating the first layer of the outer shell material, the first layer of the coating material, the layer of core material, the second layer of the coating material, and the second layer of the outer shell material to the fourth temperature.

### BRIEF DESCRIPTION OF THE DRAWINGS

Aspects of the present invention are described, by way of non-limiting examples, with reference to the following drawings, wherein like reference numbers denote substantially similar elements:

FIG. 1 is a graph showing diffusion coefficients for elements and molecules in fused silica;

FIG. 2 includes a pair of graphs that show the relationship between the viscosity of fused silica and the equilibrium for producing gas in transforming a seed into a hollow sphere;

FIG. 3 is a graph showing the temperature dependent viscosity of some commercial glasses;

FIG. 4 is a stability diagram for reactions occurring in a silicon submerged arc furnace;

FIG. 5 is a graph showing the impact of both the activity of Si and the operational pressure on the temperature of the reactor used to transform seeds into hollow spheres;

FIG. 6 is an Ellingham-Richardson diagram;

FIG. 7 is a graph showing the vapor pressure of pure elements as a function of temperature;

FIG. 8 shows the vapor pressure of SiO (P_{SiO}) and other operational conditions for carrying out a particular reaction with iron;

FIG. 9 shows the vapor pressure of SiO (P_{SiO}) and other operational conditions for carrying out another particular reaction with nickel;

FIG. 10 shows the vapor pressure of SiO (P_{SiO}) and other operational conditions for carrying out yet another particular reaction with vanadium;

FIG. 11 illustrates the deposition of silica when the monatomic oxide encounters O₂;

FIG. 12 is a graph showing total pressure and temperature associated with two particular transforming chemical reactions;

FIG. 13 is a graph showing a heating cycle for transforming seeds into VacuSpheres;

FIG. 14(a) is a graph showing a rate of producing seeds as a function of reactor diameter with CaCO₃ cores with radii of 7.3 microns;

FIG. 14(b) is a graph showing a rate of producing seeds as a function of reactor diameter with CaCO₃ cores with radii of 29 microns;

FIG. 15(a) is a graph showing a rate of producing seeds as a function of reactor diameter with SiC cores with radii of 2.6 microns;

FIG. 15(b) is a graph showing a rate of producing seeds as a function of reactor diameter with SiC cores with radii of 10 microns;

FIG. 16(a) is a graph showing a rate of producing seeds as a function of reactor diameter with Si cores with radii of 3.2 microns;

FIG. 16(b) is a graph showing a rate of producing seeds as a function of reactor diameter with Si cores with radii of 13 microns;

FIG. 17(a) is a graph showing a rate of producing seeds as a function of reactor diameter with Fe cores with radii of 3.1 microns;

FIG. 17(b) is a graph showing a rate of producing seeds as a function of reactor diameter with Fe cores with radii of 12 microns;

FIG. 18 is a block diagram of an example drop volume reactor and ancillary equipment;

FIG. 19 is a diagram that illustrates design considerations for separating glazed initial-coated cores from adhesive drops;

FIG. 20 shows numbers of seeds with 1.5-micron wall thickness processed in Δt for a single line with 10% downtime for the specified annual production;

FIG. 21 shows numbers of seeds with 3.0-micron wall thickness processed in Δt for a single line with 10% downtime for the specified annual production;

FIG. 22 is a graph showing surface areas (m²) needed for processing seed numbers of FIG. 20;

FIG. 23 is a graph showing surface areas (m²) needed for processing seed numbers of FIG. 21;

FIG. 24 is a cross sectional representation of a single 3D printed seed with adhesive;

FIG. 25 is a cross sectional view of two layers of seeds ready for heat treatment;

FIG. 26 illustrates low fusion temperature glass frit being used to lock core particulate from dispersing in the coating material;

FIG. 27 illustrates low fusion temperature glass frit, upon heat treatment, being used to both lock the position of the seed's core and prevent core particulate from dispersing in the coating material;

FIG. 28 illustrates the 3D printing of seeds without low fusion temperature glass frit;

FIG. 29 is a graph showing surface area (m²) needed for processing seed having a wall thickness of 1.5 microns using GST, with a void radius in microns;

FIG. 30 is a graph showing surface area (m²) needed for processing seed having a wall thickness of 3.0 microns using GST, with a void radius in microns;

FIG. 31 is a cross sectional view of three layers of 3D printed seeds, printed using the Grid Surface Technique;

FIG. 32(a) represents a first step in an example process for printing seeds;

FIG. 32(b) represents a second step in the example process;

FIG. 32(c) represents a third step in the example process;

FIG. 32(d) represents a fourth step in the example process;

FIG. 32(e) represents a fifth step in the example process;

FIG. 32(f) represents a sixth step in the example process;

FIG. 32(g) represents a seventh step in the example process;

FIG. 32(h) represents an eighth step in the example process;

FIG. 33 shows low fusion temperature glass frit being used to prevent core particulate from dispersing in the coating material;

FIG. 34 is a representational diagram of seeds printed in a hexagonal formation, with offset in the 3 layers;

FIG. 35 is a micro photograph of silica fume;

FIG. 36 is a micro photograph of respirable silica particulate;

FIG. 37 illustrates heat transfer mechanisms with hollow structures; and

FIG. 38 illustrates dams formed from the coating material restricting movement of the low fusion temperature glass.

### DETAILED DESCRIPTION

### Diffusion of Gas Through Silica

Diffusion of gases through silica impacts the ability to transform a seed into a hollow microsphere (HMS). The information presented in this section provides the underlying technology for some of the inventions presented in this application.

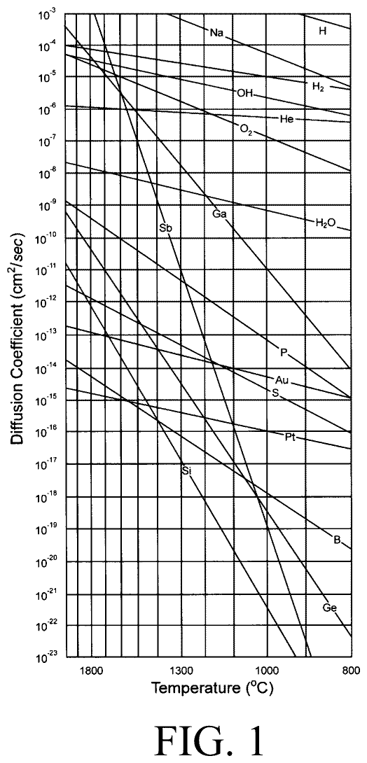

FIG. 1 is a graph showing diffusion coefficients for elements and molecules in fused silica. It is important to establish values for the diffusion coefficients of elements and molecules in silica to compute the extent gases can pass through the wall of a hollow silica microsphere (HSM) as it is formed. That information is important in computing the composition and mass of the core required to achieve the desired size of the HSM. This is not as simple a task as one might believe from viewing the graph in FIG. 1. In that figure atoms and molecules “that occupy and move through the interstitial spaces . . . are called interstitial atoms” (or molecules). “They diffuse rapidly and are at the top of the chart. Substitutional atoms replace the silicon or oxygen atoms in network . . . these diffuse much more slowly and are found near the bottom of the chart.” (Kinetic Processes by K. Jackson) Diffusion by substitution of atoms and ions is referred to as solid-state diffusion. The difference between the values for the diffusion coefficient in FIG. 1 for molecular diffusion and solid-state diffusion is a factor of 10⁻⁷.

Values for the diffusion coefficients of O₂, H₂O, OH, and several other elements for fused silica at temperatures between 800 to 2000° C. are plotted in the FIG. 1. The graph in the figure is from a book focused on production of electronic chips, and it is suspected the values are for high purity vapor-deposited silica, deposited in very thin layers not subject to the dramatic structural changes reported by Ramanathan et al., Castello and Tressler, and Zheng and co-workers in growing thicker layers of silica. If those structural changes were accounted for in FIG. 1, the line for the diffusion coefficient for O₂ would take on a greater negative slope above 1500° C., and there would be a quantum shift downward for the line due to the change to the slower diffusion mechanism reported by Ramanathan et al., Castello and Tressler, and Zheng and co-workers. That lack of discontinuity for oxygen in FIG. 1 suggests that the data at the higher temperatures has been achieved by extrapolating data from the lower temperatures. That assumption can be verified by comparing activation energies.

The rate equation for a chemical reaction is written as

$$rate = k \cdot {( consentration term )}^{n} \qquad ( 1 )$$

$$where$$

$$k = {k}_{0} \cdot exp ( \frac{- E}{R \cdot T} ) . \qquad ( 2 )$$

For diffusion control of the rate of a chemical reaction n equals 1, E is the activation energy, T is the absolute temperature, and R is the ideal gas constant. The activation energy reflects the rate controlling mechanism. For diffusion E is represented by the slope of the lines in FIG. 1 and the vertical position of the line is established by the product of

$${k}_{0} \cdot exp ( \frac{- E}{R \cdot T} ) .$$

If there is a dramatic change in E, then there is a change in the mechanism. k₀ is a weak function of temperature in comparison to the exponential term, and, thus, is considered a constant. That constant contains a frequency usually associated with thermal vibration of atoms and, for conversion of a solid, geometrical factors (flat surface versus spherical particles) associated with the shape of the material undergoing reaction. Since it is known that the rate of oxidation of SiC declines with temperature and that the activation energy is increasing, the line in FIG. 1 for O₂ must transition vertically downward to account for the slower reaction rate. Moreover, since the oxidation rate is slower, attention is focused on the exponential term as it is a direct link to the mechanism and is not impacted by the choice of how k and k₀ are expressed.

Costello and Tressler, have provided activation energies for the controlling mechanisms as the kinetic mechanism for reaction changes. The exponential terms for the reported activation energies for the transitions in mechanisms for sintered SiC are:

at low temperatures

$$exp ( \frac{- 134 kJ / mol}{R \cdot 1473 K} ) = 1.8 \cdot {10}^{- 5} and \qquad ( 3 )$$

at higher temperatures

$$exp ( \frac{- 389 kJ / mol}{R \cdot 1773 K} ) = 3.5 \cdot {10}^{- 12} \qquad ( 4 )$$

a decrease by a factor of 10^{-6.71}, while k₀ increases by a factor of 10^{1.33} from 1473K to 1773K. The overall impact of increasing the temperature is to decrease diffusion by a factor that equals 10^{-5.38} (10^{-6.71+1.33}).

The same authors report for hot pressed SiC at low temperatures

$$exp ( \frac{- 155 kJ / mol}{R \cdot 1473 K} ) = 3.2 \cdot {10}^{- 6} \qquad ( 5 )$$

that decreases by a factor of 10^{-12.2} to

$$exp ( \frac{- 498 kJ / mol}{R \cdot 1773 K} ) = 2.2 \cdot {10}^{- 18} \qquad ( 6 )$$

at higher temperatures, while k₀ increases by a factor of 10^{1.73} from 1473K to 1773K. The overall impact of increasing the temperature is to decrease diffusion by a factor of 10^{-10.5}.

Zheng et al. found for the (0001̅) crystal face that the activation energy changes from 120 kJ/mol at temperatures below 1623 K to 260 kJ/mol at temperatures above 1623 K. They conducted experiments from 1473K to 1773K. The exponential values are:

$$exp ( \frac{- 107 kJ / mol}{R \cdot 1473 K} ) = 1.6 \cdot {10}^{- 4} \qquad ( 7 )$$

That decreases by a factor of 10^{-3.71} to

$$exp ( \frac{- 255 kJ / mol}{R \cdot 1773 K} ) = 3.1 \cdot {10}^{- 8} \qquad ( 8 )$$

while k₀ increases by a factor of 10^{1.03} from 1473K to 1773K. The overall impact of increasing the temperature is to decrease diffusion by a factor of 10^{-2.68}. Their analysis of the oxidation of the (0001) crystal face produced an activation energy of 223 to 298 kJ/mol suggesting a single and slower diffusion mechanism observed at higher temperatures.

The change in the values of the exponential terms is consistent with the estimated change in the value of the diffusion coefficients associated with the change from molecular to solid-state diffusion, as determined earlier from FIG. 1, where the difference between for the diffusion coefficients between molecular and solid-state diffusion is approximately 10⁻⁷. The difference in the exponential terms reported in equations 3 to 8 range from 10⁻⁶ to 10⁻¹². This approach does not take into consideration the difference in the values for k₀.

Other investigators report high activation energies for the diffusion of oxygen through silica. Hinze et al. evaluated the oxidation of SiC and reported an activation energy of 452 kJ per mol for diffusion of oxygen over the temperature range of 1200° C. to 1550° C. (J. W. Hinze, W. C. Tripp, and H. C. Graham, The High-Temperature Oxidation of Hot-Pressed Silicon Carbide, in Mass Transport Phenomena in Ceramics, Plenum Press, New York, 1975, pp 409-419) Singhal reports, for oxidation rate controlling, an activation energy of 481 kJ/mol in hot pressed SiC containing 4 wt % Al₂O₃ over the temperature range of 1200° C. to 1400° C. (S. C. Singhal, Oxidation Kinetics of Hot-Pressed Silicon Carbide, J. Mater. Sci., vol. 11, 1976, pp. 1246-1253) Alumina is known to be a sintering aide.

Comparison of activation energies is possible using the data in FIG. 1 and fitting it to an equation,

$$ln D = ln {D}_{0} - \frac{E}{R T} \qquad ( 9 )$$

The results for the diffusion coefficient in cm²/sec are:

$${D}_{{O}_{2} Molecular} = 0.184 \cdot exp ( \frac{- 17 , 771 \cdot K}{T} ) = 0.184 \cdot exp ( \frac{- 148 kJ / mol}{RT} ) \qquad ( 10 )$$

$${D}_{{H}_{2} Molecular} = 1.58 \cdot {10}^{- 3} \cdot exp ( \frac{- 6 , 163 \cdot K}{T} ) = 1.58 \cdot {10}^{- 3} \cdot exp ( \frac{- 51.2 kJ / mol}{RT} ) \qquad ( 11 )$$

$$and$$

$${D}_{{H}_{2} OMolecular} = 1.46 \cdot {10}^{- 6} \cdot exp ( \frac{- 9 , 829 \cdot K}{T} ) = 1.46 \cdot {10}^{- 6} \cdot exp ( \frac{- 81.2 kJ / mol}{RT} ) \qquad ( 12 )$$

For solid-state diffusion of Ge and P we have the following equations:

$${D}_{GeSolid - State} = 493 \cdot exp ( \frac{- 61 , 700 \cdot K}{T} ) = 493 \cdot exp ( \frac{- 513 kJ / mol}{RT} ) \qquad ( 13 )$$

$${D}_{PSolid - State} = 5.73 \cdot {10}^{- 4} \cdot exp ( \frac{- 28 , 900 \cdot K}{T} ) = 5.73 \cdot {10}^{- 4} \cdot exp ( \frac{- 240 kJ / mol}{RT} ) \qquad ( 14 )$$

Notice that the value of the activation energy in equation 10 is similar to the values in equations 3, 5, and 7 where the authors reported the rate of oxidation of silicon carbide was limited by molecular diffusion of oxygen through the silica product. The evidence suggests that the data in FIG. 1 comes from experiments at lower temperatures and then extrapolated to higher temperatures.

### Physico-Chemical Properties of Silica and Glass

The physical and chemical properties of silica and glass impact the transformation of seeds into hollow spheres and structures.

Fused silica's softening temperature is about 1680° C. The softening point of a glass is the temperature at which it has a viscosity of 10^{7.6} Poise. At this viscosity a rod about 24 cm long and 0.7 mm in diameter elongates 1 mm/min under its own weight. Using that information and setting the density of fused silica at 2.196 g/cm³ the force per unit area (or pressure) acting on the silica to get it to flow at 1 mm per minute is 5,140 N/m² (or 0.75 psi). For glass with a density of 2.52 g/cm³ the force per unit area is 5,900 N/m² (or 0.86 psi). For hollow structures with an internal gas, an applied force is resisted by the glass and the internal pressure of the gas.

Glass can be readily formed or sealed when it has a viscosity to 10⁴ poise. That viscosity is defined as the working point of a glass.

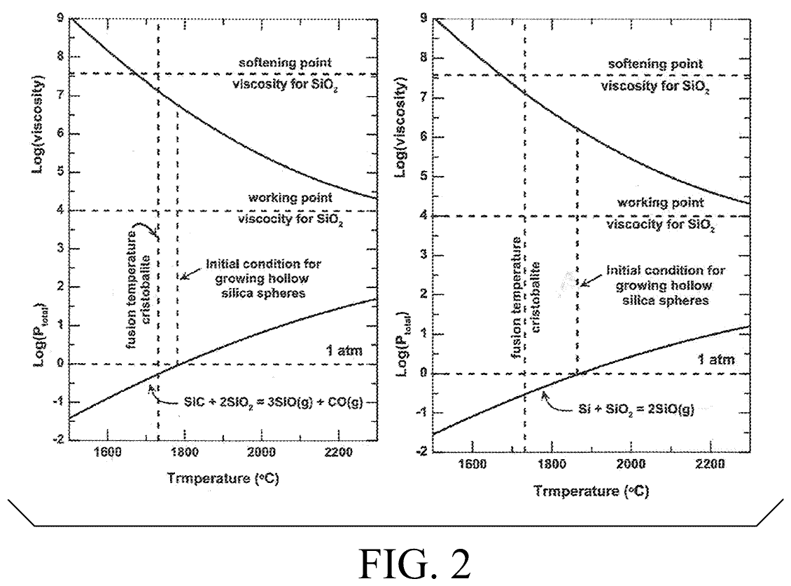

FIG. 2 includes a pair of graphs that show the relationship between the viscosity of fused silica and the equilibrium for producing gas in transforming a seed into a hollow sphere. There is considerable discrepancy as to the viscosity of fused silica at the higher temperatures. This is most likely due to the difficulty of conducting experiments at the high temperatures. High temperature use of hollow microspheres requires higher silica content in the glass forming the walls of the hollow spheres. In FIG. 2, the viscosity of fused silica is plotted as a function of temperature, as are the vapor pressures of the chemical reactions

SiC+2SiO₂=3SiO(g)+CO(g), ΔH_{2000° C.}=1,364 kJ (15)

and

Si+SiO₂=2SiO(g), ΔH_{2000° C.}=599 kJ (16)

that can be used to transform a seed into a hollow sphere. The working point temperature for fused silica has a value of approximately 2400° C.

At 2000° C. the viscosity of fused silica is 1.5 orders of magnitude more viscous than that at the working point temperature. Thus, any application force on silica at 2000° C. should be small to avoid deformation.

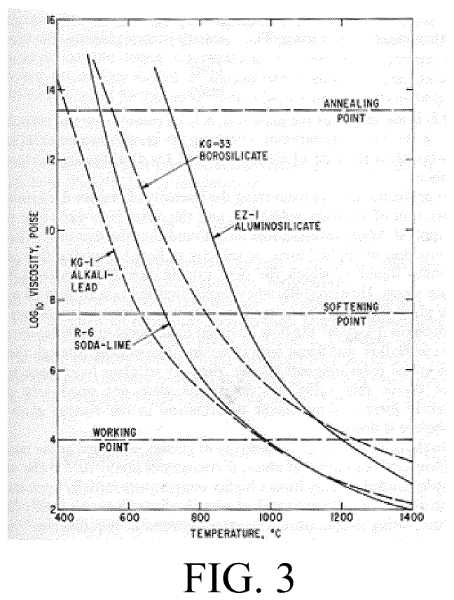

FIG. 3 is a graph illustrating how the viscosities of some commercial glasses depend on temperature.

The viscosities of fused silica and glasses plotted as a function of temperature have a negative slope. At temperatures below the softening point the slope of the line is more negative than that of the line at higher temperatures, as shown for commercial glasses in FIG. 3. A 100° C. drop in temperature below the softening temperature increases the viscosity by a factor of one-hundred for most commercial glasses as shown in the figure. Based on that analysis it is expected that hollow silica structures will have a maximum application temperature for all uses approaching 1580° C. and limited uses at higher temperatures where differential forces across the wall of a hollow sphere are small.

By adding basic compounds to fused silica it becomes, by definition, a glass. Glass and fused silica are both amorphous and can be viewed as viscous liquids, becoming more fluid with increasing temperature. Basic compounds disrupt the bonding between Si and O atoms. The distinction between acid and basic oxides in glass is the strength of the bond holding the element to the oxygen. Silica (SiO₂) has a strong covalent bond such that the oxide holds together when liquefied, forming fused silica. Silica is a network former and is referred to as an acid. Basic oxides, unlike silica, ionize upon fusion, breaking up the silica network and thus lowering its viscosity. Basic oxides, in decreasing order of basicity, are Na₂O, CaO, Li₂O, MnO, MgO, FeO, BeO, TiO₂, and Al₂O₃. Alumina and TiO₂ are amphoteric and can function as either an acid or a base. By adding a basic oxide to fused silica (now a glass with a high silica content) its viscosity is decreased. By converting fused silica to a glass, the viscosity line in FIG. 2 is shifted to the left. The seeds with a glass coating can be converted to hollow spheres at lower temperatures. That advantage, however, reduces the maximum application temperature (MAT).

FIG. 2 shows the relationship between viscosity, temperature, and gas production for fused silica. Extrapolating the lines for the chemical reactions in the graphs to the working point temperature of 2400° C. suggest that for reaction 15 the total equilibrium pressure will be approximately 100 bar and for reaction 16 the total pressure is about 30 bar. Conversely at 1 bar for the total pressure for reactions 15 and 16 the viscosity of the fused silica is 10^{6.7} and 10^{6.3} poise, respectively. Those values are below the softening viscosity, but still quite viscous.

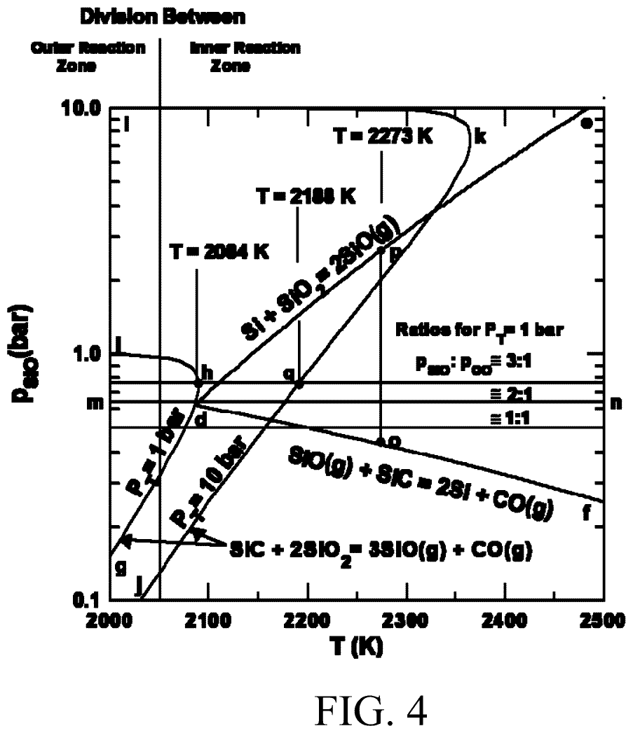

FIG. 4 is a stability diagram for reactions occurring in the silicon submerged arc furnace, as published by D. C. Lynch and C. Young, Mineral Processing & Extractive Metallurgy Handbook Vol. 2, Society of Mining Engineers, Feb. 8, 2019, p. 2082. In FIG. 4 there is pressurized data for reactions 15 and 16 which are identified in the figure. The total pressure for reaction 15 is plotted for both 1 bar and 10 bar (1 bar=0.987 atm); as lines “g-h-i” and “j-k-l,” respectively. Since reaction 16 involves only one gaseous molecule the line d-e represents all total pressures of SiO(g) up to 10 bar. Based on the diagram, to transform a seed into a hollow sphere in a reactor at 10 bar requires a temperature above 2360K (point k, 2087° C.) for reaction 15 and 2480K (point e, 2207° C.) for reaction 16.

The following patent and applications by the same inventor include related technical information and are, therefore, incorporated herein by reference in their respective entireties:

U.S. Pat. No. 11,242,252 B2 entitled Refining Process for Producing Solar Silicon, Silicon Carbide, High-Purity Graphite, and Hollow Silica Microspheres;

U.S. patent application Ser. No. 17/002,645 entitled Methods for Producing Hollow Ceramic Spheres;

U.S. patent application Ser. No. 17/468,138 entitled Methods for Producing and Products Including Hollow Silica and Hollow Glass Spheres; and

U.S. patent application Ser. No. 17/530,963 entitled Methods for Producing Seed for Growth of Hollow Spheres.

The present invention discloses additional methods for producing a chemical construct including a core and a coating surrounding the core, the construct forming a hollow structure upon heating. In this document the construct is referred to as a seed. Upon heating, the coating's viscosity decreases, while the core produces, on its own or through interaction with the coating, a gas that causes the coating to expand forming a hollow structure. In this specification that process is referred to as the transformation.

The present invention overcomes the problems associated with the prior art by providing systems and methods for producing seeds in significant numbers, seeds that can be transformed into:

hollow spheres with significantly reduced internal pressure;

hollow spheres with a maximum operational temperature at or above 2,000° C.;

honeycomb structure consisting of sealed cells; and/or

honeycomb structure consisting of sealed pores with significantly reduced internal pressure.

### Description of New Core Chemistries, Decreasing Activity

The maximum application temperature (MAT) of a HMS is based on the silica content of the coating material. Higher MAT requires higher silica content in the seed's coating. It was stated earlier that the MAT for a HMS with a pure silica wall is 1580° C. for all applications. The temperature required to transform a seed to a hollow sphere with a pure silica coating is at or above 2400° C. (the working point temperature) and, with the use of reactions 15 and 16 requiring reactor pressures of 100 and 30 bar, respectively. The transformation temperature is fixed by the viscosity of the silica and cannot be changed. The pressure at which the transformation occurs can be reduced. The ideal pressure is 1 atm.

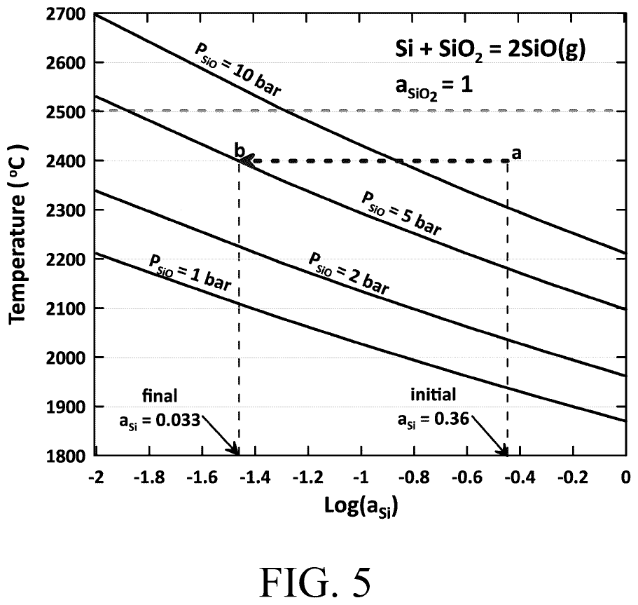

FIG. 5 is a graph showing the impact of both the activity of Si and the operational pressure on the temperature of the reactor used to transform seeds into hollow spheres. Decreasing the pressure produced by reaction in the core can be accomplished by decreasing the thermodynamic activity of any of the compounds that react to form the gas. In reaction 16 the activity of Si (a_{Si}) can be reduced by forming a molten alloy. Normal melting and boiling point temperatures for Si are 1412 and 3267° C., respectively. The impact of decreasing the activity of Si is presented in FIG. 5. At the far right in the graph the activity of pure molten Si is one. At the far left the activity of the molten Si in solution with one or more components is 0.01. The pressures of SiO(g) are the equilibrium values for reaction 16 and reflect the magnitude of the pressure in the reactor used in transforming the seeds. The computed results in FIG. 5 provide the impact of both pressurizing a reactor and reducing the activity of the silicon.

The example presented in FIG. 5 is for a reactor operated at a pressure of 5 bar. The required viscosity dictates the temperature of transformation. In this example the seed has a coating material consisting primarily of silica, which, as noted previously, has a working point temperature of approximately 2400° C. It is anticipated that the desired viscosity for transformation is at 2400° C. The seed injected into a plume of hot gas from a plasma jet is instantly heated to 2400° C. The alloy containing silicon forming the core of the seed has an activity of Si equal to 0.36, and wants to produce SiO(g) and will do so trying to reach the equilibrium pressure at point “a” in the figure, a pressure well above the 5 bar in the reactor. Since the pressure at point “a” exceeds 5 bar the reaction occurring in the core causes the seed to transform into a hollow structure. The expansion of the hollow structure continues until the wall of the structure is ruptured or the activity of the alloy in the core drops to 0.033 (point “b”).

The concept of reducing the activity of Si is being applied to raise the temperature of transformation and reduce the required pressure, while increasing the silica content of the coating material. The temperature is raised to increase the silica content of the glass and thus raise the maximum application temperature. Since the temperatures involved are above 1900° C. the reduction of the activity of silicon involves forming a liquid alloy. There are three criteria used in selecting an alloying element, they are:
1. The alloying element's ability to reduce silica in the formation of SiO(g) should be small in comparison to the ability of Si;
2. The alloying element's contribution to the vapor pressure inside the hollow sphere should be small (the goal is to raise temperature while suppressing the generation of gas at lower temperatures); and
3. The alloying element's impact on the viscosity of the glass forming the walls of the hollow structures should be small.

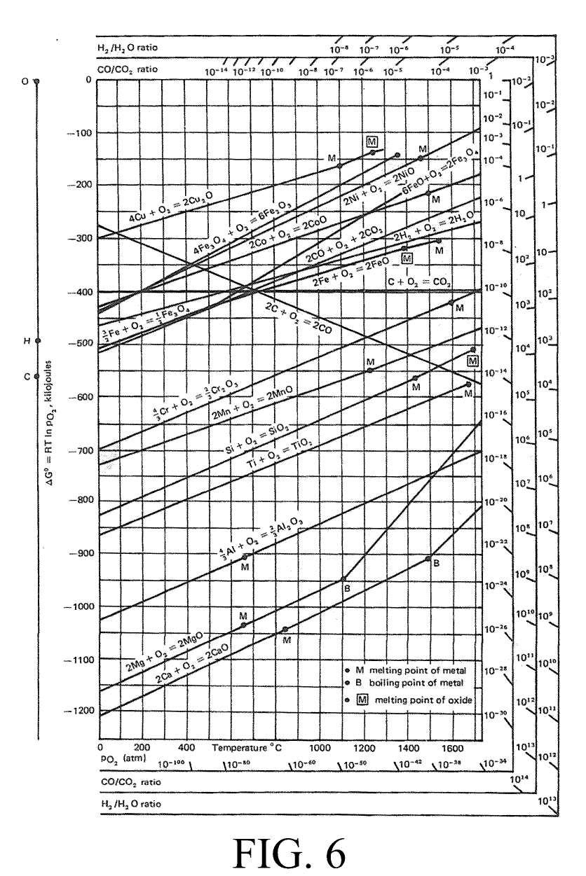

FIG. 6 is an Ellingham-Richardson Diagram. The Ellingham-Richardson diagram of FIG. 6 provides a simple means of identifying alloying elements that have limited ability to reduce silica. Lines for chemical reactions that lie below the line for

Si+O₂(g)=SiO₂ (17)

in the figure can reduce silica. The further the chemical reaction is below that for reaction 17 the greater is the possibility that those elements will violate criteria 1 above, which eliminates aluminum, magnesium, and calcium. The elements above the line for reaction 17 have less ability to reduce silica, that condition includes copper, nickel, and iron. Chemical reactions involving titanium and manganese fall in between and can be used, but at significant more cost.

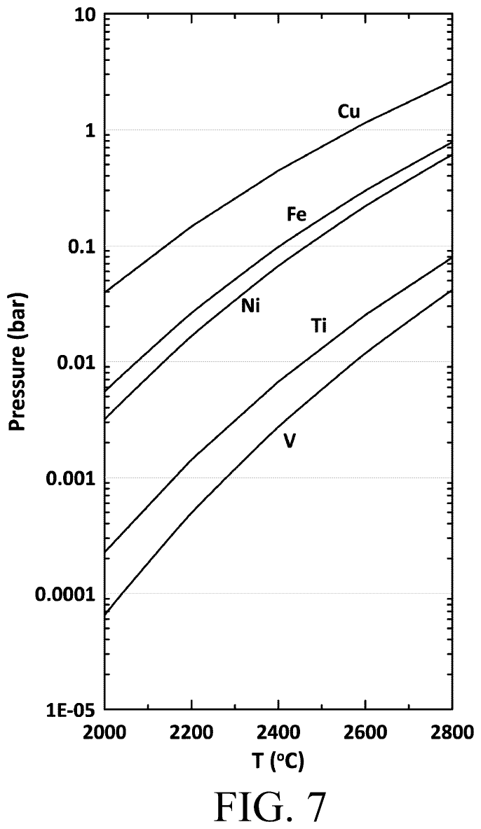

FIG. 7 is a graph showing the vapor pressure of pure elements as a function of temperature. An examination of the vapor pressure of copper, nickel, and iron in FIG. 7 leads to the removal of copper, as it violates criteria 2.

Nickel and iron can be used to reduce the activity of Si for conditions presented in FIG. 5. The oxides of nickel and iron are weak bases and, thus, will have minimal impact on the viscosity of the glass forming the walls of the hollow sphere, thereby satisfying criteria 3. The oxides are formed by the reactions

Ni+SiO₂=NiO+SiO(g) (18)

and

Fe+SiO₂=FeO+SiO(g) (19)

However, these reactions will not progress significantly as written due to the predominance of SiO(g) production by reaction 16. The oxides (NiO and FeO) that form will dissolve in the glass, however the activity of the oxides in the glass will be small and decrease with increasing vapor pressure of SiO(g).

Equilibrium constant for reaction 19 is K₁₉ and is only a function of temperature and is equal to (P_{SiO}·a_{FeO}/a_{Fe}·a_{SiO2}). The activity of the silica is approximately 1, therefore a_{FeO}=K₈·(a_{Fe}/P_{SiO}). The activity of FeO is equal to its mole fraction in the glass times an activity coefficient. At low concentration the activity coefficient is a constant. Thus, any change in the activity is due to a change in composition. The mole fraction can be converted to the weight percent of FeO.

Since the activity of a molecule in a solution is linked to concentration, a decrease in activity also results in a decrease in concentration of the component. The higher the operational pressure for the transformation of seeds, the less the oxides will impact the viscosity of the glass as explained in the preceding paragraph.

The drawbacks to the example presented in FIG. 5 are twofold. At the temperatures required to increase the silica content in the glass, Fe will form a molten alloy at all compositions with Si. With the initial heating of the seed, the seed's core seeks to produce SiO(g) with a pressure at point “a” in the figure. If the viscosity of the seed's coating is not low enough, pressure will increase inside the hollow structure leading to a rupture of the structure's wall prior to full expansion. Second, as the Si in the alloy reacts with silica forming SiO(g) (as per reaction 16) its concentration is depleted, and the reaction will stop at point “b” in FIG. 5, unless the temperature is increased or the external pressure is decreased.

An alternative approach to the variable activity of Si is to have Si combine with W, Ta, or Zr at an overall composition in a 2-phase region in any of the three binary systems (Si—W, Si—Ta, and Si—Zr). The suggested alloy elements have high melting point temperatures and will form 2-phase regions with Si at the temperatures of interest. With overall composition in a 2-phase region the activity of Si remains constant even as its concentration is reduced. This only applies if the overall concentration of Si remains within the 2-phase region.

### Magnetic Hollow Structures

Ni and Fe, as previously demonstrated, can be used to reduce the activity of silicon in producing hollow spheres with walls containing a higher silica content. The activity of silicon can be related to the mole fraction of Si in the molten metal alloy. At elevated temperatures, all solutions become ideal, where activities equal their mole fraction. Phase diagrams for Fe—Si and Ni—Si reveal that compositions of iron rich and nickel rich solutions with Si at low temperatures fall below the Curie temperature. At temperatures below the Curie Temperature, it is possible to form a permanent magnet by applying an alignment field. It is, thus, possible to produce magnetized hollow spheres.

### Description of New Core Chemistries, New Reducing Agents

An alternative chemistry is presented for producing hollow spheres with high silica content glass walls. In the previous section elemental Fe and Ni alloyed with Si was used to reduce the activity of silicon and thereby allow use of reaction 16 at higher temperatures with reduced internal pressure within the seed as it is transformed into a hollow structure. That reduced internal pressure is, with respect to that plotted in FIG. 5; the pressure being reduced from 80 bar (from FIG. 2) to about 5 bar. While that approach can be used to produce hollow spheres with magnetic properties, it comes with added cost associated with the pressure of operation.

The new process is a modification to the previous approach that can be employed to reduce the pressure of transformation by eliminating elemental Si in the core of the seed. Reactions 18 and 19 are repeated here along with the reaction for vanadium:

Ni+SiO₂=NiO+SiO(g), (18)

Fe+SiO₂=FeO+SiO(g), (19)

and

⅖V+SiO₂=⅕V₂O₅+SiO(g) (20)

Without elemental silicon these reactions proceed as written to near complete consumption of the metal. The oxides of the metals dissolve in the glass, reducing its viscosity and thus lowering its maximum application temperature. However, this approach has a distinct advantage in reducing the external pressure required for a controlled transformation at a fixed pressure. Note that both FeO and NiO are weak bases, thus their presence in fused silica will have a minor impact on the viscosity and the maximum application temperature.

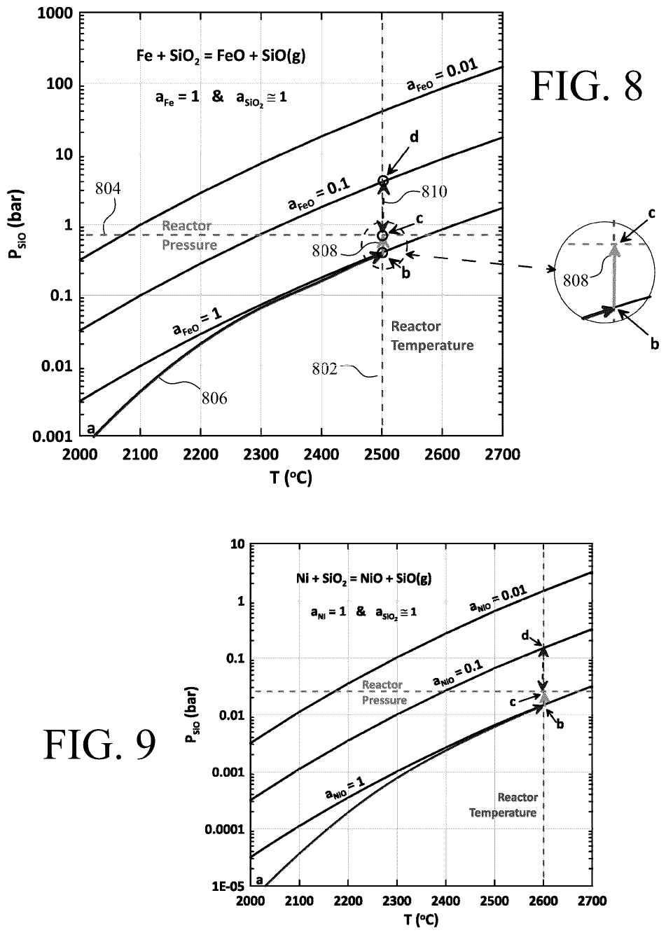

FIG. 8 shows P_{SiO} and operational conditions for Reaction 19. Iron is used in the first example, as it is the least expensive metal of those found in reactions 18 through 20. The vapor pressure of SiO for reaction 19 is plotted as a function of both temperature and the activity of FeO in FIG. 8. The metallic iron is not capable of reducing silica to elemental Si and forming an alloy, thus its activity is constant and has a value of 1. The initial activity of the silica is 1, but by dissolving FeO as the reaction proceeds, its activity declines. However, the mass of silica is significantly greater than that of Fe in the seed. Thus, the activity of SiO₂ retains a value of approximately 1.

Seeds consisting of an iron (or a combination of Fe and SiO₂) core and a fused silica coating are injected into a plasma plume where the temperature and pressure of the plume are represented by dashed lines 802 and 804, respectively, in FIG. 8. As the seed is heated, the reaction between the iron and silica produces SiO(g). The pressure of that gas within the seed is represented by the line 806 in the graph. Line 806 approaches the equilibrium line for reaction 19 as the temperature rises and the kinetics of the reaction are fast enough to generate the ever-increasing pressure of SiO(g), as represented by line 806 between points “a” and “b.” Not included with line 806 is the vapor pressure of Fe which, as the data in FIG. 8 indicates, is significant. That vapor pressure of Fe raises the total pressure as represented by arrow 808, between points “b” and “c” in FIG. 8. The total pressure at point “c” is for unit activity of FeO, which is by way of example and should not be considered limiting.

Once the seed reaches the conditions at point “b” the transformation of the seed into a hollow sphere begins. The viscosity of fused silica at 2500° C. is, as noted earlier, expected to be lower than the working point viscosity which occurs at approximately 2400° C. Iron oxide produced by the reaction is initially pure, but immediately begins to dissolve in the fused silica. That process reduces the activity of FeO, and the graph in FIG. 8 indicates it raises the equilibrium pressure of SiO. That increase in SiO pressure is represented by dashed line 810, between point “c” and “d.” The line is in dashed form as the increase in pressure is never realized. As the pressure increases the void inside what is now becoming a hollow structure grows, reducing the total pressure to that at point “c.” It is thus possible to transform a seed at a fixed pressure.

FIG. 9 shows the vapor pressure of SiO (P_{SiO}) and other operational conditions for carrying out Reaction 18. Note that Ni is not a viable candidate for reactor operations at 1 atmosphere, because the viscosity of fused silica would be too low at 2600° C.

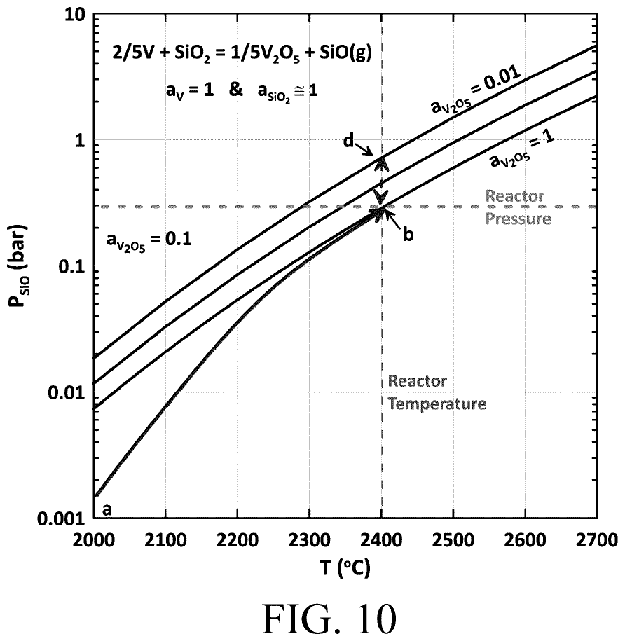

FIG. 10 shows the vapor pressure of SiO (P_{SiO}) and other operational conditions for carrying out Reaction 20. The graph for V does not include point “c” as the vapor pressure of elemental V is too small to include its impact in the drawing.

It appears in FIG. 8 that iron can be used with fused silica. Based on earlier discussions regarding the working point temperature of fused silica, operating the reactor at 2500° C. and at a pressure of 1 atmosphere is possible. Both iron and vanadium can be used at temperatures between 2400 to 2600° C. However, at the lower temperatures the reactors would need to be operated under modest vacuum, a condition that can be achieved with a low-cost mechanical pump.

The bond strength between oxygen and Ni is the weakest of the 3 elements in reactions 18 through 20. Elements with a stronger bond with oxygen can strip an oxygen atom away from silica at lower temperatures. It is thus possible to apply the concept presented in FIGS. 8, 9 and to elements that can further lower the operational temperature, while maintaining an operational pressure of 1 atmosphere. However, lowering the temperature leads to problems with silicide formation and metals that retain their solid form, and at lower temperatures transformation of seeds would not involve fused silica, but a glass with a lower working point temperature.

In all cases the temperature is selected based on the viscosity of the seed's coating.

### Description of Diffusion Issues and VacuSpheres

A VacuSphere is defined here as a hollow structure with an internal pressure at room temperature below 0.001 atm and that it will take more than 1,000 years for the internal pressure to rise to 0.01 atm in the presence of air at room temperature. To produce a VacuSphere it is important to isolate SiO(g) from reactions 16, 18, 19, and 20, and SiO(g) plus CO(g) from reaction 15, within the interior of the hollow structure. The chemical reactions that produce a VacuSphere are presented in Table I.

TABLE I

| | Chemical Reaction Upon Cooling |
|---|---|
| Chemical System | Leading to Near Perfect Vacuum |
| SiC & SiO₂ | 3SiO(g) → 1.5Si + 1.5SiO₂ |
| | 1.5Si + CO(g) → SiC + 0.5SiO₂ |
| Si & SiO₂, | 2SiO(g) → Si + SiO₂ |
| Fe & SiO₂, | |
| Ni & SiO₂, | |
| V & SiO₂, and | |
| M* & SiO₂ | |

*M represents any element or compound that can partially reduce SiO₂ forming SiO(g) and an oxidized form of M.

Diffusion of gases through silica impacts the ability to produce a VacuSphere. However, evidence indicates that CO can be used to transfer heat to seeds without significantly impacting the composition of the gas phase that forms in transforming a seed into a hollow sphere. Costello and Tressler reported that in the oxidation of hot pressed SiC in air the rate of reaction slowed at higher temperatures (1400 and 1500° C.) and then increased. Physical presence of bubbles and craters were present in the product layer, suggesting that rupture of the oxide film by escaping gas was the source of the increased reaction rate. The formation of bubbles occurred at silica layer thickness of 1.5 microns for sintered SiC and 4.7 microns for hot pressed SiC. The equilibrium constant for the reaction

2SiC+3O₂(g)=2SiO₂+2CO(g), ΔH_{1,500° C.}=−1,883 kJ (21)

at 1500° C. is 4.1·10⁴⁷. If the partial pressure of oxygen at the SiC—SiO₂ interface is assumed to be 10⁻⁶ or 10⁻¹² bar, the pressure of CO(g) can be as high as 6.4·10¹⁴ bar or 6.4·10⁵ bar, both pressures certain to rupture the oxide layer. When O₂ and CO pass through the silica layer by molecular diffusion they will do so at similar rates as their kinetic diameters are similar, 346 and 376 pm, respectively. There cannot be a significant buildup of CO pressure at the reaction interface with molecular diffusion as the gases use the same channels to pass through the silica layer. The two gases are coupled in molecular diffusion. However, with solid-state diffusion the movement of oxygen and carbon operate on separate structural paths, their diffusion is decoupled. Costello and Tressler's findings strongly suggest the following.
1. At 1400° C. the structure of the oxide layer formed by the chemical reaction changes as the thickness increases causing diffusion to shift from molecular to solid-state.
2. At 1500° C. the change described in item 1 occurs at a thickness of 1.5 microns for sintered SiC and 4.7 microns for hot pressed SiC. This suggests that as the thickness of the layer increases the impact of the crystal nature of the SiC on the silica formed during the carbide's oxidation diminishes. The thickness of the coating material on a seed for producing a HMS 1.5-100 is 33 microns, and for HMS 3.0-400 is 103 microns.
3. Solid-state diffusion of carbon through the silica at higher temperatures is significantly slower than that of oxygen.
   These findings suggest that CO(g) is the ideal gas to be used in transforming a seed into a hollow structure as its ability to pass through the glass forming the seeds coating is limited. The SiC—SiO₂ system produces CO(g) during transformation and reduces the concentration gradient of CO across the glass layer, reducing the driving mechanism for diffusion. Additionally, the use of CO(g) can be heated with a Quantum furnace (or similar device) with reduced damage to electrodes.

Oxidation of SiO(g) can block molecular diffusion. Air and water vapor should be considered in transforming seeds to hollow spheres given their low cost. Water vapor on heating will undergo some dissociation forming H₂(g) and O₂(g). For the Si—SiO₂ and SiC—SiO₂ systems both O₂(g) and H₂O(g) act as oxidizers.

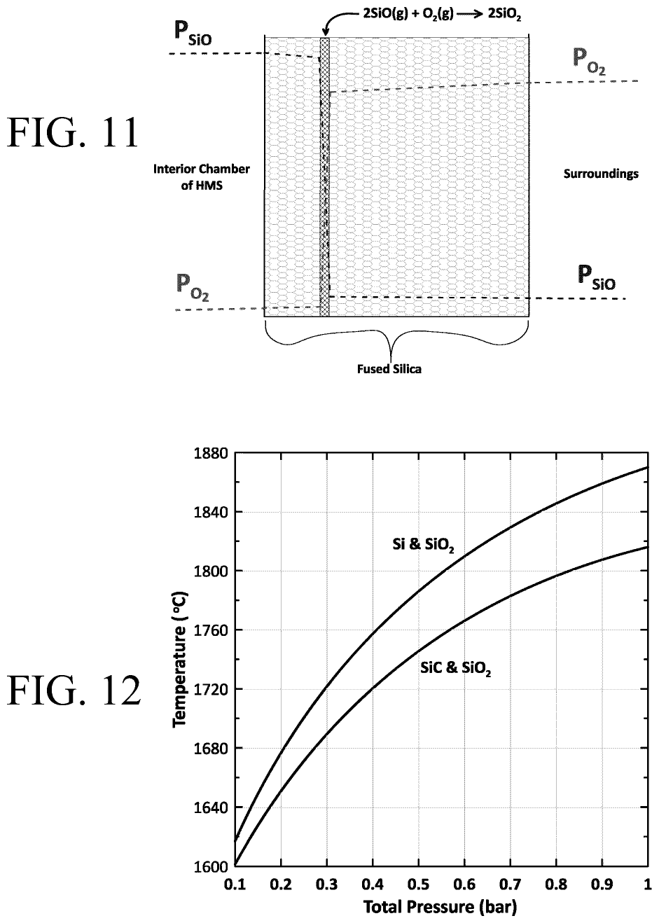

FIG. 11 illustrates the deposition of silica when the monatomic oxide encounters oxygen (O₂). With the advent of the production of SiO(g) and the availability of oxygen, the SiO(g) is converted to Silica. The deposition of the silica fills pores, forming roadblocks to further diffusion of oxygen. Any oxidizer can be substituted for O₂ in the drawing.

During transformation of a seed to a hollow structure, in an oxidizing atmosphere, small crystals of SiO₂ (and possibly some fused silica) form, blocking molecular diffusion as the seed is transformed, effectively isolating the core of a seed from its surroundings. Production of SiO(g) by any of the reactions presented earlier leads to deposition of silica when the monatomic oxide encounters O₂ (or any other oxidizing agent) as shown in FIG. 11. The location of this layer within the wall of a hollow sphere is a function of the diffusion coefficients. With slower movement of SiO(g) as compared to the oxidizer the deposition of SiO₂ will be nearer the internal surface of the wall. With the deposition of the silica, resistance to diffusion now resides over a thin shell, where partial pressures of O₂ and SiO drop precipitously as shown in the drawing.

At 1870° C. and at ambient pressure the interior pressure of oxygen is 9.4·10⁻¹⁵ bar. The SiO pressure on the surroundings side of the barrier is about 4.7·10⁻¹⁴ bar.

The oxidizer that enters the hollow sphere as it is formed reacts with SiO(g) or Si reducing their concentrations. That loss must be accounted for by adding additional material (Si or SiC) to the seeds core.

During cooling of a HSM, deposition of SiO(g) is represented by the chemical reactions presented in Table I. The cooling of SiO(g) deposits as Si and SiO₂, whereas the combination of SiO(g) and CO(g) produces SiO₂ plus SiC. The deposition of these materials can occur in the voids of the wall of the hollow structure further isolating the interior of the structure from its surroundings. Deposition of SiO(g) begins at temperatures above 1200° C., continues to temperatures as low as 800° C., and is highly likely at lower temperatures. The reported limiting temperature is based on the lowest top bed temperature in the operation of a silicon submerged arc furnace.

Cooling of HSMs will likely require a soak time at a temperature that allows the gases in the interior of the HSMs to react as presented in Table I, thereby producing the desired vacuum inside the HSMs.

There are glasses that precipitate into two separate and intermingled phases with heat treatment. The intermingled phases block passageways, limiting molecular diffusion of gases through interstitial sites. The extent of phase separation will depend on glass composition and the heat treatment.

### Description of Production Chemistries for Producing VacuSpheres

The material in this section is directed to the transformation of a seed into a hollow structure by chemical reactions 15 and 16.

Variables that can be used to manage production of VacuSpheres include: Pressure and Temperature; Excess Si of SiC; Choice of Gas as Medium for Transferring Heat; Vacuum Treatment; and/or Inert Treatment.

### Pressure and Temperature

The pressure-temperature relationships involved in transforming seeds to hollow spheres are presented in FIG. 12.

### Excess Si or SiC

Excess Si or SiC ensures that there will be adequate supply of reactant to prevent a concentration buildup of oxidizer in the hollow structure as it is cooled. The value of diffusion coefficients increases with temperature, and, thus, the addition of excess Si and SiC become important at the higher temperatures.

### Choice of Gas as Medium for Transferring Heat

An oxidizer can significantly impact the oxidation rate of SiO(g), lead to inclusion of non-reactive gases in the hollow structure, and alter the ability to produce a vacuum in the structure.

### Vacuum Treatment

A vacuum, or partial vacuum, can remove non-reactive gases.

### Inert Treatment

In lieu of the vacuum treatment, a purified inert gas (possibly N₂ at 700° C., a temperature below that where SiO(g) decomposes to Si and SiO₂) may be used to remove unwanted gases in the hollow sphere such as H_{2(g)} by diffusion.

Given the high temperatures involved in transforming seeds, and the need for rapid heating, a plasma torch is one means for heating gases. Another approach, e.g., with the use of H₂O(g), is a commercial system for producing super-heated steam. These suggested heating methods are provided by way of example and are not to be considered as limiting. Seed injection into hot gases can be by elutriation. Seeds are ionized using a corona electrostatic spray gun or a tribo gun to keep them and the hollow spheres separated.

An advantageous condition for producing hollow spheres is at ambient pressure, thereby decreasing the cost and complexity of the equipment. It is possible to transform seeds to hollow spheres using CO, H₂O, and air. While the use of air has economic advantage, it poses some additional problems and limitations. Those problems are best addressed by examining diffusion of gases through the wall of a hollow structure, and their impact on the internal environment of a hollow structure as it is produced.

FIG. 12 shows total pressure and temperature associated with the two transforming chemical reactions 15 and 16.

Several chemistries can be used in the transformation of a seed to a hollow structure and then cooling it to produce an internal vacuum. A major component in the process is the structural characteristics of the seeds coating as the seed transitions to a hollow sphere. Earlier it was noted that in the rate of oxidation of SiC it is controlled by molecular diffusion of oxygen at temperatures below 1400° C. Experimental data for the oxidation of SiC reveals that the structural characteristic of the silica product layer changes with increasing temperature. At higher temperatures the diffusion mechanism shifts from molecular to a solid-state diffusion, a slower mechanism for transporting oxygen. In this application it has been shown that the structural change in the silica has a more remarkable impact on the solid-state diffusion of CO than that of oxygen. The temperature of transforming a seed at 1 bar are, from FIG. 12, 1817° C. for reaction 15 and 1870° C. for reaction 16. Lacking values for solid-state diffusion coefficients in silica at elevated temperatures, molecular diffusion coefficients from FIG. 1 are modified by a Structural Characterization Factor (SCF) for computations. Molecular diffusion coefficients were altered by SCFs of:
10⁻⁶ for solid-state diffusion;
10⁻⁴ for high degree of transition from molecular to solid-state diffusion;
10⁻² for low degree of transition from molecular to solid-state diffusion; and
10⁰ for diffusion coefficients as presented in FIG. 1.

The computed results provide a means to evaluate use of various environments in the transformation of seeds to hollow structures. Environments for the transformation of seeds include, but are not limited to, the following examples.

### CO(g) and Seeds

Transformation Pressure & Temperature—1 bar at 1870° C. for Reaction 16 and 1817° C. for Reaction 15
Diffusion Coefficient for CO(g)—The kinematic diameter of CO is 8.7% larger than O₂, and both molecules are linear. However, O₂ is nonpolar, while CO is a polar molecule. It is anticipated that CO's molecular diffusion through fused silica is, in comparison to O₂, slowed slightly by its size and slowed more by interaction of the polar characteristic of CO with silica. A lower value for the molecular diffusion coefficient, as compared to O₂, is expected. Unfortunately, there is no data for CO in FIG. 1. However, without measured numbers, and to be conservative, molecular D_{CO} was set equal to molecular D_{O}_{₂} and multiplied by the Structural Characteristic Factor. Analysis of Costello and Tressler data as presented in this application strongly suggest the SCF is 10⁻⁶ and most likely smaller.
Structural Characteristic Factor—Calculations suggest that VacuSpheres can be formed with Structural Characteristic Factors (SCF) of 10⁻⁶, 10⁻⁴, and 10⁻². At SCF of 10° the need for excess Si (Reaction 16) and SiC (Reaction 15) in the seed's core ballooned but can still be used in transforming a seed.
Excess Si or SiC

None at SCF equal to 10⁻⁶

3× (3 times) at SCF equal to 10⁴

7× at SCF equal to 10⁻²
Reduction Initiator—CO acts as a reducing initiator for SiO(g) production at high temperatures (e.g., it assists Si in reducing SiO₂ to SiO(g)) and as an oxidizer at lower temperatures, where it reacts with SiO(g) forming SiO₂ and SiC. The low temperature reactivity of CO(g) is important in preventing it from concentrating in the hollow structure, CO(g) elimination leaving only SiO(g) to undergo further condensation during the final quench.
Nonreactive Gases—None are produced in the use of CO(g). If produced, nonreactive gases would reduce the vacuum within a hollow sphere. Vacuum treatment before quenching can be used to reduce the pressure of the nonreactive gas within the hollow sphere.
Interior Vacuum of VacuSphere—Approximately 10⁻¹⁰ bar or lower by reverse of reaction 16, and 10⁻⁸ bar by reverse of reaction 15.
Heat Source—Heating can be accomplished by plasma torch or by passing O₂ over hot carbon to produce CO, and upon recycle of CO with oxygen impurity the O₂ impurity can be converted to CO by again passing the gas over hot carbon.
Comment—Carbon monoxide is recycled to avoid greenhouse gas emissions and should be cleansed of N₂ prior to recycle (The assumption is that air may contaminate the gas, and contamination is to be avoided.).

### H₂O(g) and Seeds

Transformation Pressure & Temperature—1 bar at 1870° C. for Reaction 16 and 1817° C. for Reaction 15, H₂O(g) undergoes partial dissociation forming small quantities of H₂(g) and O₂(g).
Diffusion Coefficient for H₂O(g), H₂(g), and O₂(g)—Values for the diffusion coefficients for H₂O(g), H₂, and O₂ were taken from FIG. 1 and multiplied by the SCF. Water vapor has a smaller kinematic diameter than O₂ (265 versus 346 pm), and yet it has a much smaller molecular diffusion coefficient than that of O₂. That difference is due to the nonlinear shape of the H₂O molecule and its high polar characteristics, with uncovered (i.e., lacking nearby electrons) protons at each end of the molecule.
Structural Characteristic Factor—Calculations indicate that VacuSpheres can be formed with SCFs of 10⁻⁶, 10⁻⁴, and 10⁻². At SCF of 10⁰ the need for excess Si or SiC in the seed's core ballooned but can still be used in transforming a seed.
Excess Si 1× at SCF equal to 10⁻⁶
   1× at SCF equal to 10⁻⁴
   1× at SCF equal to 10⁻²
Reduction Initiator—A reduction initiator may be required. Possible additions include adding Al to the core or carbon to the seed's coating. CO can also be used as a reduction initiator during the transition of the seed to a hollow sphere. Oxidation of SiO(g) to SiO₂ and its blocking of interstitial sites will eliminate the need for further reduction initiator.
Nonreactive Gases—H₂ remains in the hollow sphere, and because of its high diffusion coefficient and its small size the interior pressure of H₂ matches its exterior pressure. Under a vacuum, or with a purified inert gas, the hydrogen pressure in a hollow sphere can be reduced to 10⁻⁴ bar within a short period at 700° C. Nonreactive gases reduce the vacuum within a hollow sphere. Vacuum treatment before quenching can be used to reduce the pressure of the nonreactive gas within the hollow sphere.
Interior Vacuum of VacuSphere—10⁴ bar or lower.
Heat Source—Heating can be accomplished by, for example, plasma torch or by commercial units for producing super-heated steam.
Comment—Working with super-heated steam requires safety precautions.
   H₂O(g) Plus 4% or more H₂ and Seeds
Transformation Pressure & Temperature—1 bar at 1870° C. for Reaction 16 and 1817° C. for Reaction 15, H₂O(g) undergoes partial dissociation forming a smaller quantity of O₂ as compared to using H₂O on its own.
Diffusion Coefficient for H₂O(g), H₂(g), and O₂ (g)—Values for the diffusion coefficients for H₂O(g), H₂(g), and O₂ (g) were taken from FIG. 1 and multiplied by the structural characteristic factor. Water vapor has a smaller kinematic diameter than O₂ (265 versus 346 pm), yet it has a much smaller diffusion coefficient than that of O₂. That difference is due to the nonlinear shape of the H₂O molecule and its high polar characteristics, with uncovered protons at each end of the molecule.
Structural Characteristic Factor—Calculations suggest that VacuSpheres can be formed with SCFs of 10⁻⁶, 10⁻⁴, 10⁻², and 10⁰.
Excess Si 0.1×SCF equal to 10⁻⁶
   0.1× at SCF equal to 10⁻⁴
   0.1× at SCF equal to 10⁻²
   4× at SCF equal to 10⁰
Reduction Initiator—A reduction initiator may be required. Possible additions include adding Al to the core or carbon to the seed's coating. CO can also be used during the transition of the seed to a hollow sphere. Oxidation of SiO(g) to SiO₂ and its blocking of interstitial sites eliminates the need for further reduction initiator.
Nonreactive Gases—H₂ remains in the hollow sphere, and because of its high diffusion coefficient and small size the interior pressure of H₂ matches its exterior pressure. Under a vacuum or purified inert atmosphere the hydrogen pressure in a hollow sphere can be reduced to 10⁻⁴ bar within a short period at 700° C. Nonreactive gases reduce the vacuum within a hollow sphere. Vacuum treatment before quenching can be used to reduce the pressure of the nonreactive gas within the hollow sphere.
Interior Vacuum of VacuSphere—10⁻⁴ bar or lower.
Heat Source—Heating can be accomplished, for example, by plasma torch or by commercial units for producing super-heated steam.
Comment—Working with super-heated steam requires safety precautions.

### Air and Seeds

Transformation Pressure & Temperature—1 bar at 1870° C. for Reaction 16 and 1817° C. for Reaction 15
Diffusion Coefficient for N₂(g), and O₂ (g)—Values for the diffusion coefficient for O₂ were taken from FIG. 1 and multiplied by the structural characteristic factor. N₂ has a larger kinematic diameter than O₂ (364 pm versus 346 pm) and like oxygen is nonpolar. The triple bond in N₂ is significantly stronger than the double bond in O₂, a condition that will slow solid-state diffusion of nitrogen. Thus, vales for D_{N}_{₂} were set at D_{O}_{₂}·10⁻¹ and then multiplied by the appropriate SCF.
Structural Characteristic Factor—Calculations suggest that VacuSpheres can only be formed with air at SCFs equal to 10⁻⁶.
Excess Si 0.1× at SCF equal to 10⁻⁶
Reduction Initiator—A reduction initiator may be required. Possible additions include adding Al to the core or carbon to the seed's coating. CO can also be used during the transition of the seed to a hollow sphere. Oxidation of SiO(g) to SiO₂ and its blocking of interstitial sites for diffusion eliminates the need for further reduction initiator.
Nonreactive Gases—N₂ remains in the hollow sphere, and, because of its diffusion coefficient, the interior pressure of N₂ is difficult to reduce within a reasonable time under a vacuum. Nonreactive gases reduce the vacuum within a hollow sphere. Vacuum treatment before quenching can be used to reduce the pressure of the nonreactive gas within the hollow sphere.

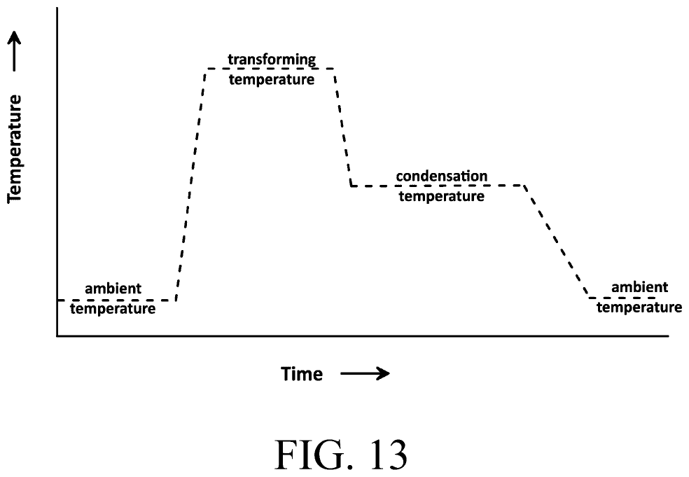

Interior Vacuum of VacuSphere—Not applicable, however it is possible that D_{N}_{₂} is substantially smaller than that used in the analysis, given the strength of the triple bond in N₂. If that is the case with N₂ a VacuSphere can be produced with air.
Heat Source—Heating can be accomplished, for example, by plasma torch.
Comment—While working with air is more economical that other gases, it does pose an oxidation problem that might reduce or eliminate SiO(g) formation. A general thermal cycle for producing VacuSpheres is presented in FIG. 13. A seed is heated to a transforming temperature where the chemical reaction occurring in the seed's core and the gas it produces causes the glass coating the core to expand. After the transformation is complete the hollow structure's temperature is reduced to allow SiO(g) to condense, producing SiO₂ and Si for Reaction 16. The deposition process for Reaction 15 is more complicated. As presented in Table I, the SiO condenses producing SiO₂ and Si, and the latter reacts with CO(g) producing both SiC and SiO₂. The hollow spheres are held at the condensation temperature until the desired vacuum is attained, and the hollow sphere is now a VacuSphere. Finally, the VacuSpheres are cooled to ambient temperature.

If a nonreactive gas or gases (nonreactive is defined as a gas in a hollow structure that retains a pressure greater or equal to 0.001 atmospheres at room temperature) are concentrated inside the hollow structure, they must be removed to an acceptable level (by vacuum treatment or exposure to a purified inert gas at an elevated temperature, possibly N₂ for hydrogen removal). Spheres are held at the condensation temperature until the desired vacuum is attained, and the hollow sphere is now a VacuSphere. Finally, the VacuSpheres are cooled to ambient temperature.

### Description of the Uncontrolled Pressure Technique for Transforming a Seed

In the previous discussions, in transforming a seed into a hollow sphere, the goal has been to produce a seed coating that is sufficiently fluid to respond to a slight positive pressure differential between the gas generated within the seed and the surrounding pressure. In this section the transformation of a seed without controlling the pressure differential is described.

In producing hollow structures with a high MAT, it is important to raise the silica content of the glass of the hollow sphere. Raising the silica content requires transforming the seed at elevated temperatures, temperatures where chemical reactions 15, 16, and 21 produce gases with a total pressure greater than 1 atmosphere. The goal here is to identify the conditions that make it possible to transform a seed where the differential pressure across the seed's coating is substantial.

If the pressure differential is to be ignored, and there is successful transformation of seeds to hollow spheres, it will occur because:
rapid heating of the exterior of a seed;
sufficient resistance to heat transfer from the surface of the seed to the interface between the seed's coating and core; and/or
an endothermic chemical reaction occurring at sufficient speed that it cools the core.

Reaction 15 and 16 are both endothermic, thus criteria 3 is satisfied for those reactions, except for the fact that the rate must be fast enough to cool the core but not so fast as to raise the pressure to a point where it will rupture the see's coating.

Reaction 21 is exothermic and, thus, represents a special case that is examined at the end of this section.

If a plasma torch (or Quantum furnace) is used with injection of seeds into the plasma plume, the heat transfer coefficient to the seed will be exceptionally large, thus the surface temperature will instantly be that of the plasma, satisfying criteria 1. With rapid heat transfer to the core, there is the potential for the temperature of the coating to become too hot, reducing the viscosity of glass to a value that allows the gas generated within the seed to easily rupture the coating. That outcome can be avoided by injecting seeds into the plasma plume with a separate gas, to decrease the temperature of the plume.

The impact of heat transfer across the seed's coating, the variation in the viscosity of the glass, and the kinetics of the chemical reaction require a balance to achieve a high yield of seeds being transformed into hollow spheres with the uncontrolled pressure technique.

The impact of the internal pressure on this approach to transforming seeds to hollow spheres can be reduced by using the chemistries identified in the sections entitled “Description of New Core Chemistries, Decreasing Activity” and “Description of New Core Chemistries, New Reducing Agents” presented above.

Earlier in the section entitled “Description of Diffusion Issues and VacuSpheres” analysis of research results published by Costello and Tressler presented in this document reveals that at temperatures above 1400° C. the diffusion of O₂ and CO through silica changes from molecular diffusion to solid-state diffusion. That change in mechanism can produce CO pressures at the interface between the SiC core and the silica coating to substantially exceed 1 bar. A similar shift in diffusion mechanism can occur with a glass with significant silica content. Thus, it is possible to transform a seed with a SiC core and coating consisting of a glass or glass frit heated in air to a temperature of 1400 to 1550° C., provided the glass's viscosity can respond the pressure of CO created by reaction 21.

### Description of Seed Production Using Drop Volume Technique

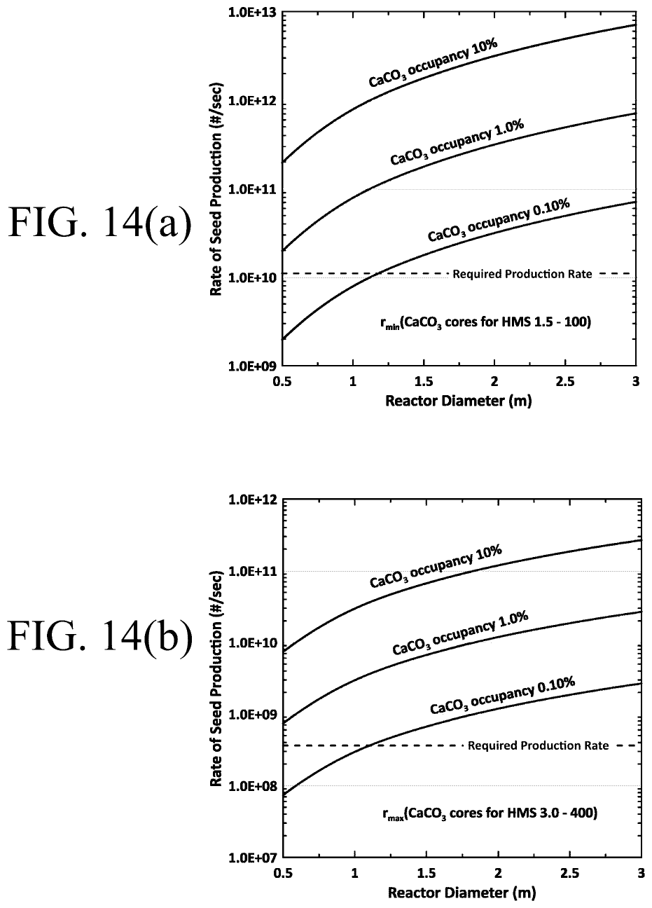

The Drop Volume Technique (DVT) can produce a large volume of green-seeds (or constructs) at a rapid pace, and at ambient conditions with the use of adhesive. Continuous production is based on treating all seed-cores in a specified volume. That volume is defined by the cross-sectional area of the reactor times the distance the core can fall (the Drop in DVT) in one second after injection to the reactor. That distance is computed using Stokes' law or the graphs for friction factors plotted as a function of the Reynolds number for submerged objects. The Drop and the cross-sectional area of the reactor defines the Volume in DVT. That volume is injected with cores. Numbers have been calculated for injecting cores into the reactor occupying 10%, 1%, 0.1% of the volume as a function of the reactor's diameter. The results of those calculations are presented FIGS. 14(a) through 17(b).

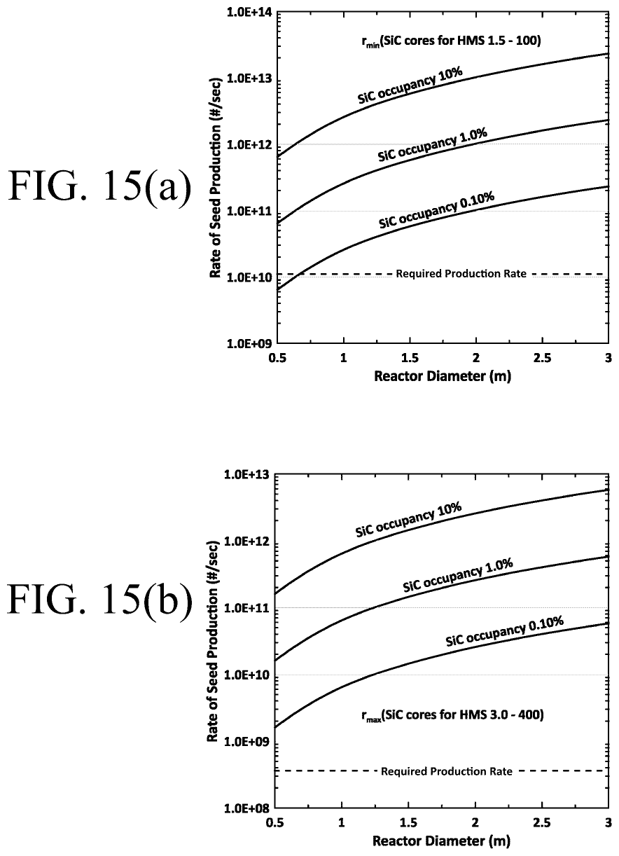

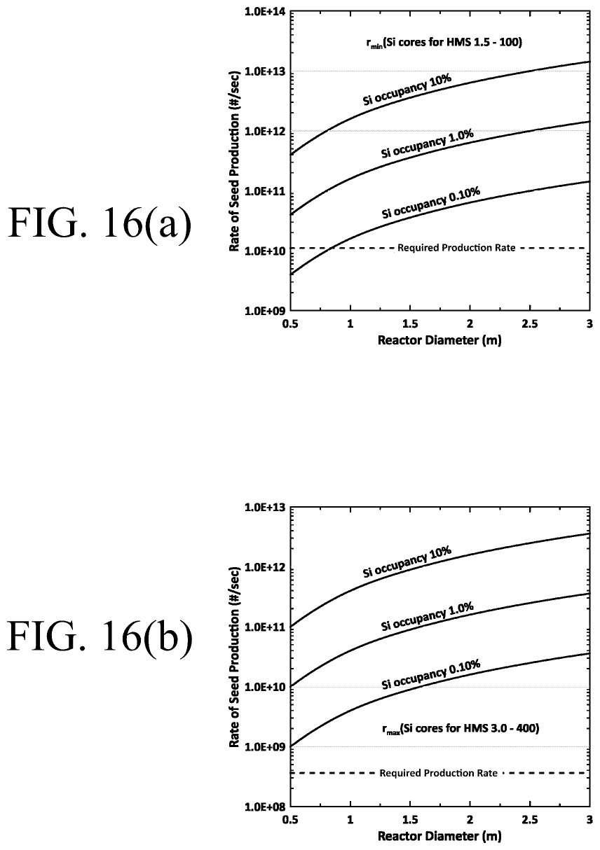

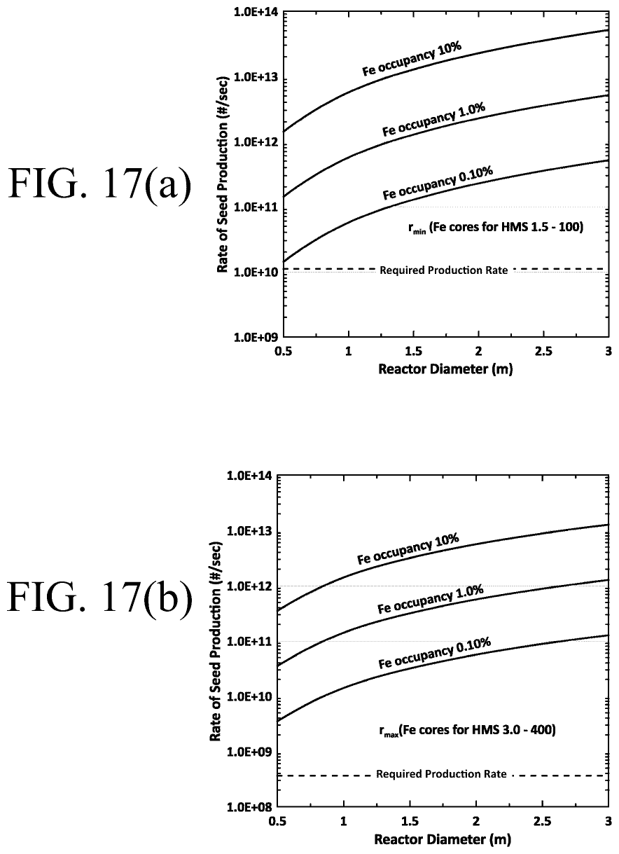

In FIGS. 14(a), 14(b), 15(a), and 15(b), the numbers are based on processing in air at 27° C. In FIGS. 16(a), 16(b), 17(a), and 17(b), the numbers are based on processing in nitrogen at 27° C.

The designations “renin” and “r max” in those diagrams refer to the smallest and largest sizes of the cores used in the calculations. Numbers for “rₘᵢₙ” and “rₘₐₓ” vary depending on the core material and the chemistry that produces the gas that transforms a seed into a hollow sphere. The notation in the figures “HMS 1.5-100” stands for Hollow Microsphere with a wall thickness of 1.5 micron and a radius of 100 microns. Similarly, “HMS 3.0-400” refers to hollow spheres with 3.0-micron walls and a radius of 400 microns. The “Required Production Rate” for all the graphs and for the two sizes of hollow spheres is based on annually producing approximately 167,000 tonnes of seeds per reactor.

The required production rates appear to be the same in each diagram for rₘᵢₙ and rₘₐₓ. The similarity in the numbers is because the mass of the seed's coating far exceeds that for the core. Thus, the difference associated with the mass of the cores for the different chemistries is masked by the logarithmic scale in the diagrams.

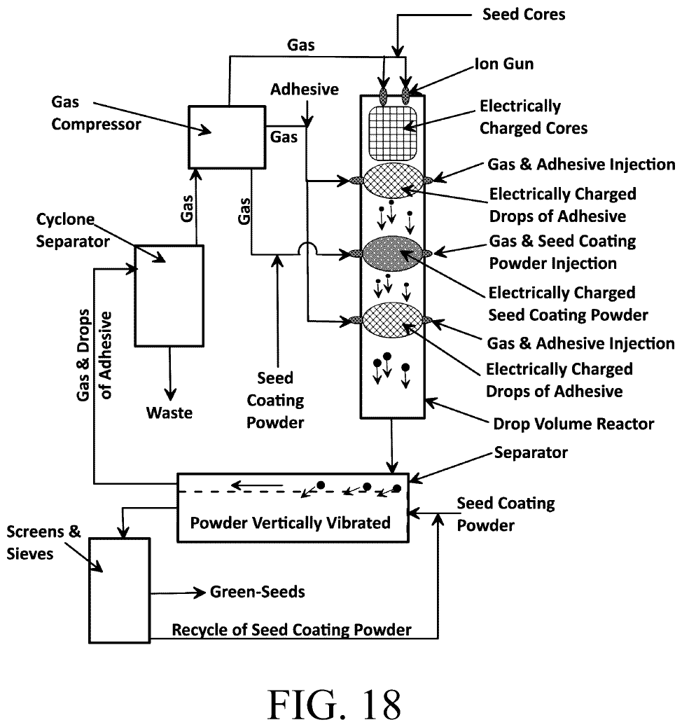

An example of a drop volume reactor and auxiliary equipment is presented in FIG. 18. The equipment consists of a vertical reactor, a gas compressor used to inject seed cores, droplets of adhesive, and seed coating powder to the vertical reactor through either corona electrostatic spray guns for negative electrical charge or tribo guns for a positive charge. The choice of electrical charge should alternate. If seed cores are injected with a tribo gun then the droplets of adhesive are injected with a corona electrostatic spray gun, which is followed by injecting seed coating powder with a tribo gun, and finally more adhesive droplets are injected with a corona spray gun.

Although not shown, the wall of the Drop Volume Reactor can be divided into segments using a non-conducting insulator between segments to allow each segment to take on either a positive or negative charge to repel the cores, adhesive, glazed-cores, initial-coated-cores, and glazed-initial-coated-cores from adhering to the walls of each segment.

A glazed-core is a core covered in adhesive. An initial-coated-core is a glazed-core covered in coating particulate. A glazed-initial-coated-core is an initial-coated-core covered in adhesive. A Green-Seed has all desired coats of adhesive and coating particulate.

The shape of the Drop Volume Reactor need not be limited to a cylinder. For example, an alternate shape might include a frustum to alter gas velocities or limit particle interaction with the reactor wall.

The glazed-initial-coated-cores leaving the Drop Volume Reactor fall into a vibrated bed of seed-coating-powder, which adheres to the adhesive on the exterior of the glazed-initial-coated-cores. The vibration of the bed is sufficient to toss powder up and have it cover the glazed-initial-coated-cores.

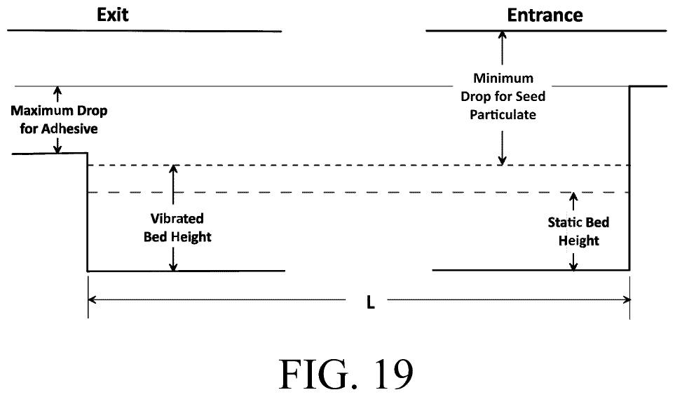

The vibrated bed is housed in a closed volume, as shown in FIG. 19, with a small vertical clearance between the bed and the top of the housing. The horizontal length of the bed and the clearance between the bed and the top of the housing must be small enough for the glazed-initial-coated-cores to fall, leaving them trapped in the bed before the gas leaves the housing. However, the velocity of the gas passing through the housing needs to be fast enough and the size and density of the adhesive droplets small enough that they are transported out of the housing.

FIG. 19 illustrates design considerations for separating glazed initial-coated cores from adhesive drops. FIG. 19 presents an idealized design for the entrance and exit for the housing of the vibrated bed. Over the length of the bed that the gas (laden with particulate and fine droplets of adhesive) passes the particulate (cores, glazed-cores, or glazed-initial-coated-cores) drops the minimum distance identified in FIG. 19, while the fine droplets of adhesive cannot drop more than the maximum as presented in the diagram. Some coating powder, glazed and unglazed, may pass through the housing with the droplets of adhesive. Green Seeds can be segregated from the fine coating powder, after the adhesive is cured, by use of screens and sieves. The composite particles can be lightly milled after the adhesive is cured and coating powder recycled for further use.

The vibrating bed can be on a conveyor belt (or similar device) moving the bed material in either horizontal direction. Alternatively, a rotary mixer, or similar device, can be used to replace the vibrating bed.

The gas leaving the vibrating bed's housing passes to a cyclone separator where the droplets of adhesive as well as any solid material carried by the gas are removed before the gas is sent to the compressor. The waste stream from the cyclone separator consists of adhesive and solid particulate. A series of baffle plates can be used instead of a cyclone separator to achieve the separation of the gas from the droplets of adhesive and solid particulate. The cyclone separator can be replaced with any device that achieves the desired separation of the gas from solid particulate and liquid droplets.

The product from the first DVT reactor can be passed through additional reactors to increase the size of the Green-Seed or to provide additional coatings of selective powders. That addition of a selective coating can be accomplished in any of the DVT reactors.

The green seeds packed in a friable material can be heated to a temperature where coating particulate surrounding the seed's core either sinters or fuses. The temperature is selected to not initiate the transformation of the seed into a hollow structure. The heat-treated seeds can be recovered from the friable powder by sieving (or other physical means). Some light milling may be required to free the seeds from the friable packing material.

### Description Methods for Producing Seeds by the Close Pack Surface Technique (CPST)

The CPST's series of steps can be modified to produce seeds that, once transformed into a hollow sphere, have any of the properties described in U.S. patent application Ser. No. 17/468,138. The CPST and its multiple steps can, with automation, meet required seed production.

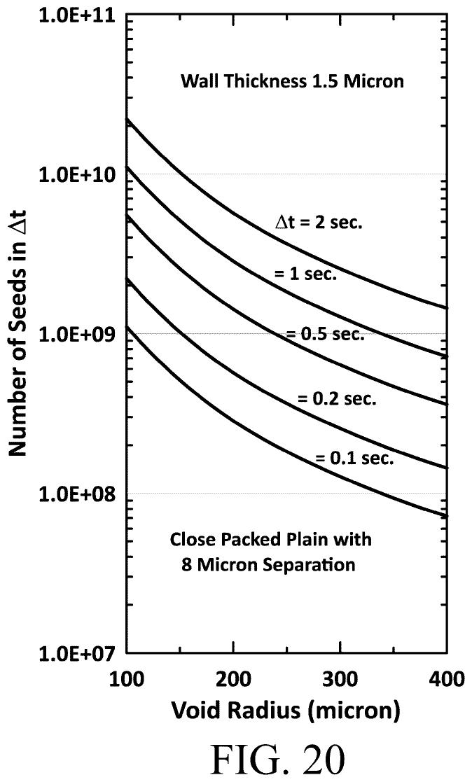

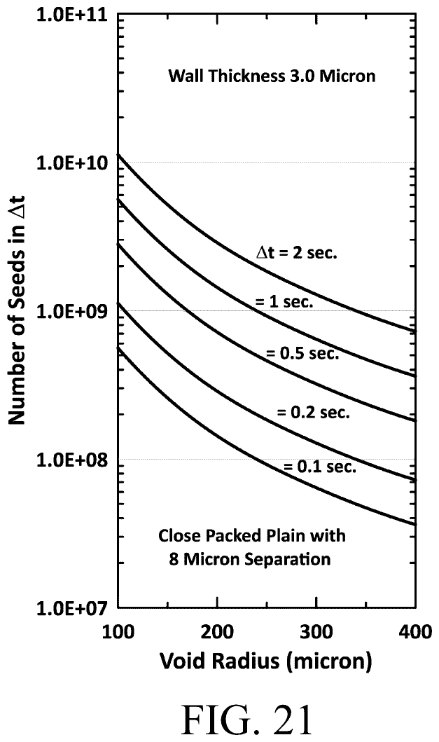

How many seeds need to be produced and at what rate? The simplest approach is to view each production step in the list for the CPST as a batch process. With that assumption the slowest step (in Δt) dictates the number of seeds that must be processed in each step to meet annual production. Those numbers, for a single line (1 out of five), are presented in FIGS. 20 and 21 for hollow spheres ranging in size with radii from 100 to 400 micron. Five lines process 835,000 tonnes annually. FIG. 20 shows numbers of seeds with 1.5-micron wall thickness processed in Δt for a single line with 10% downtime for the specified annual production. FIG. 21 shows numbers of seeds with 3.0-micron wall thickness processed in Δt for a single line with 10% downtime for the specified annual production. The seed numbers look daunting, but one must remember that while the numbers are large the size of the seed is small. Thus, it is necessary to examine the production rate in terms of surface area that must be treated in the CPST.

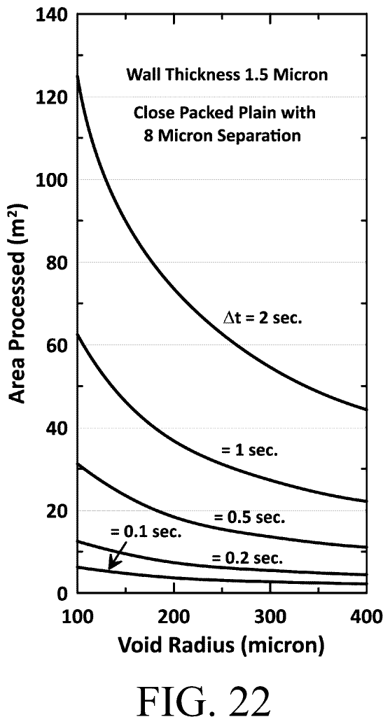

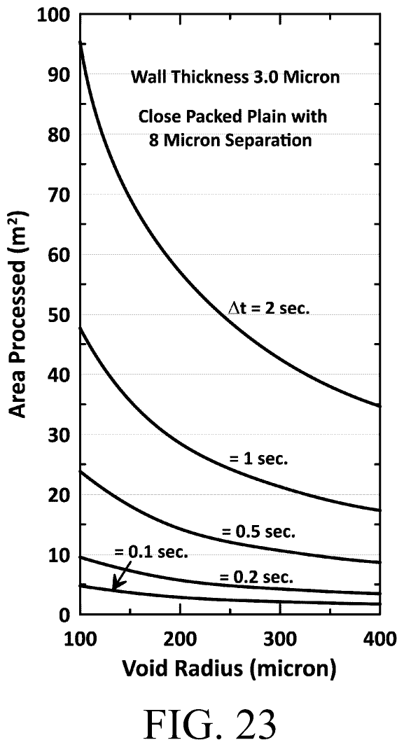

With close packing of the circles the surface area requirement can be computed for the total number of seeds presented in FIGS. 20 and 21. The areas associated with the numbers in those figures are presented in FIGS. 22 and 23. The area that requires treatment ranges from approximately 125 m² in 2 seconds for the smallest hollow microstructure with a 1.5-micron wall to about 2 m² in 0.1 seconds for the largest HMS with a 3-micron wall. Automation provides rapid repetitive operations suitable for seed production using 3-dimensional (3D) printing.

With fixed stations for the different steps in the list of steps for the CPST, the slowest step with a fixed production rate dictates the size of surface area being treated. If the slowest step takes 2 seconds in processing green-seeds, the area being processed in each step will be about 125 m² for HMS 1.5-100. If it is determined that processing of the seeds require twenty 2-second sequential operations the area requirement remains the same, namely 125 m² must be completed every 2 seconds. The additional 2 second operations only identify the required area for processing, not the rate of production. The area for processing and the procedures for processing can be adjusted by:
1. Increasing the number of production lines;
2. Producing seeds in trays with the trays being processed in series; and/or
3. Producing seeds in trays with the trays being processed in parallel.

Producing seeds in trays with the trays being processed in series includes specifying the area of a tray, placing the tray in a multi-processing carriage that can perform all steps needed to produce green-seeds. This requires the multi-processing carriage to move with the tray as it moves along the production line. The length of the line is dictated by the time to complete all processing steps, the size of the tray, and the required rate of seed production. Once the processing is completed the tray is released and the carriage is returned to where it is again loaded with another tray to begin the processing trip. This approach allows the producer to set the size of the tray; the smaller the tray the larger the number of carriages needed with a fixed production rate.

If any disruption in the processing occurs with a single carriage, that carriage can be removed from the production line without disrupting processes occurring in all the other carriages. Alternatively, the carriage can remain in the production line without further processing of material. Once the carriage reaches the end of the production line it can be removed for repair or maintenance. This is an advantage with respect to the classical production line where a disruption can bring an entire line to a stop.

A major disadvantage to processing in series with a moving multi-processing-carriage is in supplying materials and utility services.

Producing seeds in trays with the trays being processed in parallel includes specifying the area of a tray, placing the tray in a multi-processing carriage that can perform all steps needed to produce green-seeds. Processing occurs in the stationary carriage positioned next to the production line (conveyor belt). After all processing steps are completed, the tray is released to the production line and a new tray inserted in the carriage. This approach allows the producer to set the size of the tray; the smaller the tray the larger the number of carriages needed with a fixed production rate. This approach eliminates the problem of supplying materials and utility services to moving carriages processed in series.

Any disruption in the processing will occur within a single multi-processing-carriage. The carriage can be removed from its fixed position or serviced in place while production continues in all the other carriages. If the carriage is removed another can at once be put in its place. If there is a problem with a tray, it can be removed and another put in its place and processing in the carriage can be restarted, again without disrupting what is occurring in the other carriages.

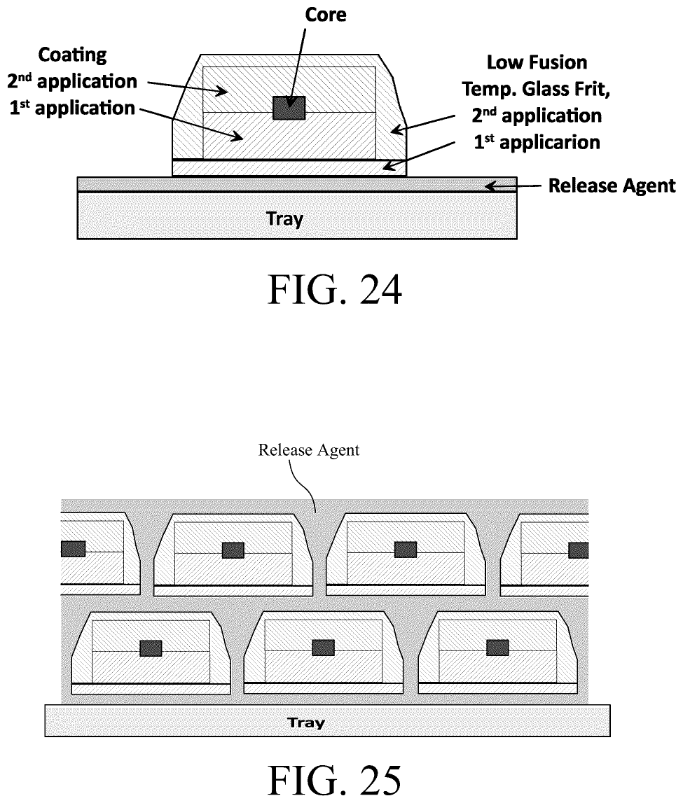

FIG. 24 is a cross section of a seed 3-dimensionally (3D) printed, with the aid of adhesive. A 3D printer can be used to print seeds with and without adhesive added to powdered material. A layer of a release agent is placed on the tray, which may or may not contain adhesive. The tray with release agent can be prepared in advance of 3D printing of the seed, if desired. A layer of a low fusion glass frit with adhesive, the size of a seed, is laid on top of the release agent with 3D printing as shown in FIG. 24. The first application of coating material is applied with 3D printing along with low temperature glass frit, the latter with adhesive. The low fusion glass frit with adhesive surrounds the coating material as shown in FIG. 24. The coating material may not require adhesive, provided the low fusion glass frit with adhesive can act as a containment vessel for the coating and core particulates. The seed's core is 3D printed on the first application of the coating material. If adhesive is not applied with the coating material, it is recommended that adhesive be applied with the core particulate. The second application of coating material is applied with 3D printing along with low temperature glass frit, the latter with adhesive. The low fusion glass frit with adhesive surrounds the coating and core materials as shown in FIG. 24. Finally, a layer of the low fusion glass frit is laid down over the top of the seed.

Application of the coating material can be applied in two separate operations as shown in FIG. 24 or laid down in a single continuous operation along with the core particulate.

FIG. 25 is a cross sectional view of two layers of seeds ready for heat treatment. Individual seeds are printed simultaneously and covered with the release agent, as shown in FIG. 25, with a second layer of seeds printed on top of the first layer. Multiple layers can be printed, stacked on top of each other, prior to heat treatment. Not shown in FIG. 25 are the side walls that prevent horizontal movement of the particulate used in forming the seeds and release agent.

The layer of seeds packed in release agent is initially heated slowly to burn off adhesive, without the escaping gas altering the seed-constructs shown in FIG. 25. After burn-off the temperature is increased to where the low fusion glass frit either sinters or fuses forming a hard shell surrounding the coating particulate that has experienced some sintering to keep the core particulate in place. The heating temperature is low enough so as not to initiate transformation of the seed into a hollow sphere. The heated material is allowed to cool, and the seeds separated from the release agent. Slight milling may be required. The seeds can be recovered by sieving or other physical separation procedures. Slight milling may be required.

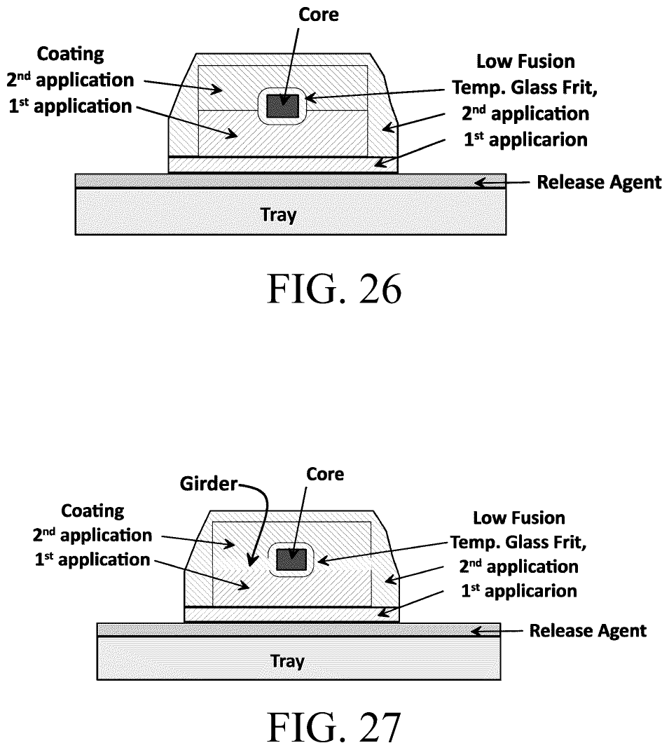

FIG. 26 illustrates the use of low fusion temperature glass frit to lock core particulate from dispersing in the coating material. If the heat treatment is not sufficient to achieve sufficient sintering of the coating material to keep the core particulate in place, a small layer of low fusion temperature glass frit with adhesive (or without) can be 3D printed around the core, as shown in FIG. 26, to keep the core particulate from dispersing in the coating material.

In FIG. 27 low fusion temperature glass frit upon heat treatment is used to both lock the position of the seed's core and prevent core particulate from dispersing in the coating material. In FIG. 27, the low fusion temperature glass frit surrounds the core, and girders of the glass frit extend to the outer shell of the low fusion temperature glass frit. These additions of glass frit can include adhesive. The locations of the girders in FIG. 27 are not to be considered as limiting.

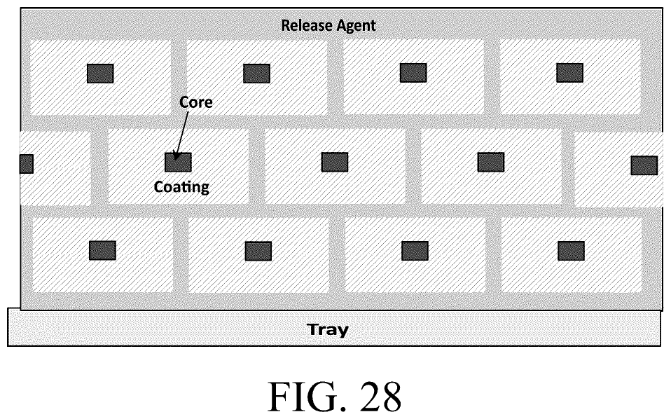

FIG. 28 illustrates the 3D printing of seeds without the low fusion temperature glass frit. Seeds can be printed without the low fusion temperature glass frit. A layer of a release agent is placed on the tray, it may or may not contain adhesive. The tray with release agent can be prepared in advance of 3D printing of the seed, if desired. Coating material and release agent are printed simultaneously or nearly simultaneously so that the coating is laid down with release agent present, to prevent unwanted spreading of the coating material. As the height of the coating material rises, eventually three materials are being applied: release agent, coating, and core particulates. Again, the printing of the materials is accomplished in a fashion that eliminates unwanted spreading of the particulate. After applying the last of the core particulate, printing resumes with the addition of release agent and coating material. Once all the coating material has been applied a layer of release agent is applied to the entire area of the tray, as shown in FIG. 28, and construction of a new layer of seeds begins. Side walls, not shown in FIG. 28, prevent unwanted horizontal movement of the particulate. Adhesive can be used with one or more of the particulate materials; release agent, coating, and/or core powders.

The layer of seeds separated by release agent are initially heated slowly to burn off adhesive (if applied), without the escaping gas altering the seed-constructs shown in FIG. 28. After burn-off the temperature is increased to where the coating particulate either sinters or fuses, forming a hard coating surrounding the seed's core. If only sintered, the porosity of the coating should be such as to eliminate or minimize physical migration of core particulate to keep the core particulate in place. The heating temperature is low enough so as not to initiate transformation of the seed into a hollow sphere. The heated material is allowed to cool, and the seeds separated from the release agent. Slight milling may be required. The seeds can be recovered by sieving or other physical separation procedures.

Application of the coating material can be applied in two separate operations as shown in FIGS. 26 and 27 or laid down in a single continuous operation.

3D printing is done in layers, the thickness of each layer being dependent on minimizing mixing of particulates of the different materials. The printing of all materials in a layer is done simultaneously or nearly simultaneously.

The Close Packed Surface Technique has the versatility to produce seeds that, when transformed, meet the requirement for all applications covered in U.S. patent application Ser. No. 17/468,138, entitled Methods for Producing Hollow Silica and Hollow Glass Spheres.

Seeds produced in the CPST process can be produced in any shape, and configuration.

### Description of Methods for Producing Seeds by the Grid Surface Technique (GST)

The Grid Surface Technique (GST) has versatility, simplicity, and the use of adhesive can be minimal or eliminated. The seeds in the GST are produced in sheets and sintered in sheets, without a friable material. The sheets can then be used to produce the honeycomb structure described in U.S. patent application Ser. No. 17/530,963, entitled Methods for Producing Seed for Growth of Hollow Spheres (see e.g., FIG. 6).

The GST's series of steps can be modified to produce seeds that, once transformed into hollow spheres, have any of the properties described in U.S. patent application Ser. No. 17/468,138. The GST and its multiple steps can, with automation, meet required seed production.

In the following example, seeds are produced in sheets, and sheets on top of sheets, forming a block of seeds for producing the honeycomb structure upon transforming the seeds. The use of cubic, hexagonal, or any interlocking shape for seeds, versus spherical seeds, will produce the desired honeycomb shape with minimal open space between the hollow structures.

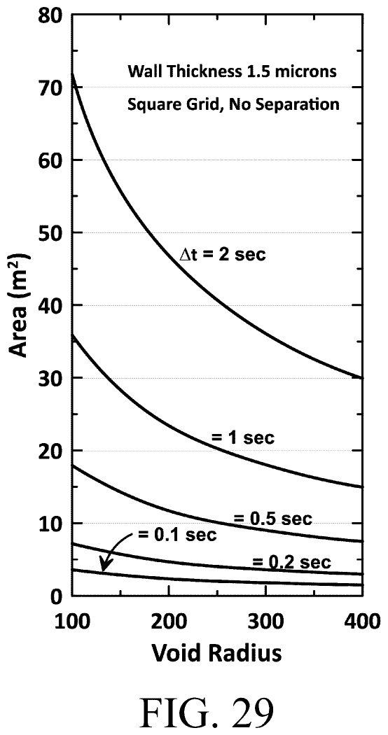

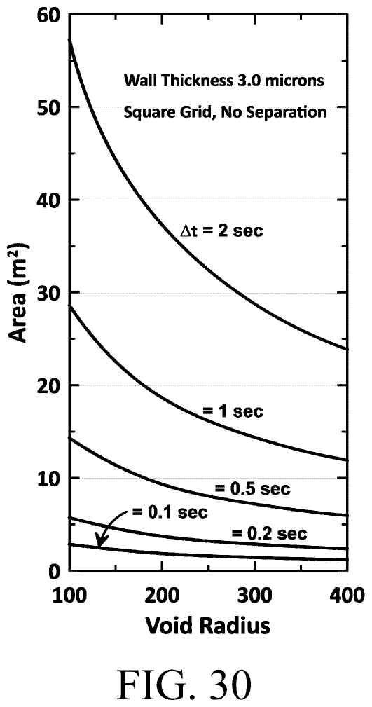

GST makes greater use of material as compared to material use in the CPST. That occurs because there is no separation distance with the GST as the seeds are formed. The area that must be processed with the GST has been computed using the number of seeds that must be produced as presented in FIGS. 20 and 21. The results of those calculations are presented in FIGS. 29 and 30. FIG. 29 is a graph showing surface area (m²) needed for processing seed having a wall thickness of 1.5 microns using GST, with a void radius in microns, and FIG. 30 is a graph showing surface area (m²) needed for processing seed having a wall thickness of 3.0 microns using GST, with a void radius in microns; With fixed stations for the different steps in the list of operations for the GST, the slowest step with a fixed production rate dictates the size of surface area being treated. If the slowest step takes 2 seconds in processing green-seeds, then the area being processed in each step will be about 72 m² for HMS 1.5-100. If it is determined that processing of the seeds require twenty 2-second sequential operations the area requirement remains the same, namely 72 m² must be completed every 2 seconds. The additional 2 second operations only identify the required area for processing, not the rate of production. The area for processing and the procedures for processing can be adjusted by:
1. Increasing the number of production lines;
2. Producing seeds in trays with the trays being processed in series; and
3. Producing seeds in trays with the trays being processed in parallel.

Producing seeds in trays with the trays being processed in series requires specifying the area of a tray, placing the tray in a multi-processing carriage that can perform all steps needed to produce green-seeds. This requires the multi-processing carriage to move with the tray as it moves along the production line. The length of the line is dictated by the time to complete all processing steps, the size of the tray, and the required rate of seed production. Once the processing is completed the tray is released and the carriage is returned to where it is again loaded with another tray to begin the processing trip. This approach allows the producer to set the size of the tray; the smaller the tray the larger the number of carriages needed with a fixed production rate.

If there is a disruption in the processing occurring with a single carriage, the carriage can be removed from the production line without disrupting processes occurring in all the other carriages. Alternatively, the carriage can remain in the production line without further processing of material. Once the carriage reaches the end of the production line it can be removed for repair or maintenance. This is an advantage with respect to the classical production line where a disruption can bring an entire line to a stop.

A major disadvantage to processing in series with a moving multi-processing-carriage is in supplying materials and utility services.

Producing seeds in trays with the trays being processed in parallel requires specifying the area of a tray, placing the tray in a multi-processing carriage that can perform all steps needed to produce green-seeds. Processing occurs in the stationary carriage positioned next to the production line (conveyor belt). After all processing steps are completed, the tray is released to the production line and a new tray inserted in the carriage. This approach allows the producer to set the size of the tray. The smaller the tray, the larger the number of carriages needed with a fixed production rate. This approach eliminates the problem of supplying materials and utility services to moving carriages processed in series.

Any disruption in the processing will occur within a single multi-processing-carriage. The carriage can be removed from its fixed position or serviced in place while production continues in all the other carriages. If the carriage is removed another can at once be put in its place. If there is a problem with a tray, it can be removed and another put in its place and processing in the carriage can be restarted, again without disrupting what is occurring in the other carriages.

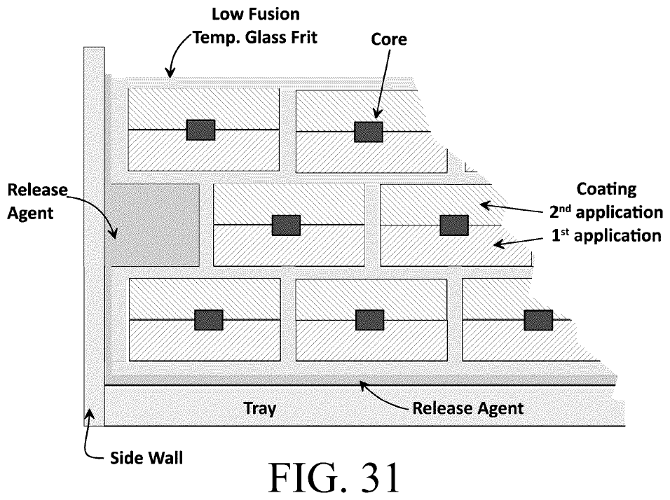

A cross sectional view of 3D printed seeds is presented in FIG. 31. More particularly, FIG. 31 is a cross sectional view of three layers of 3D printed seeds using the Grid Surface Technique. The additional release agent in the second row can be replaced by a smaller seed.

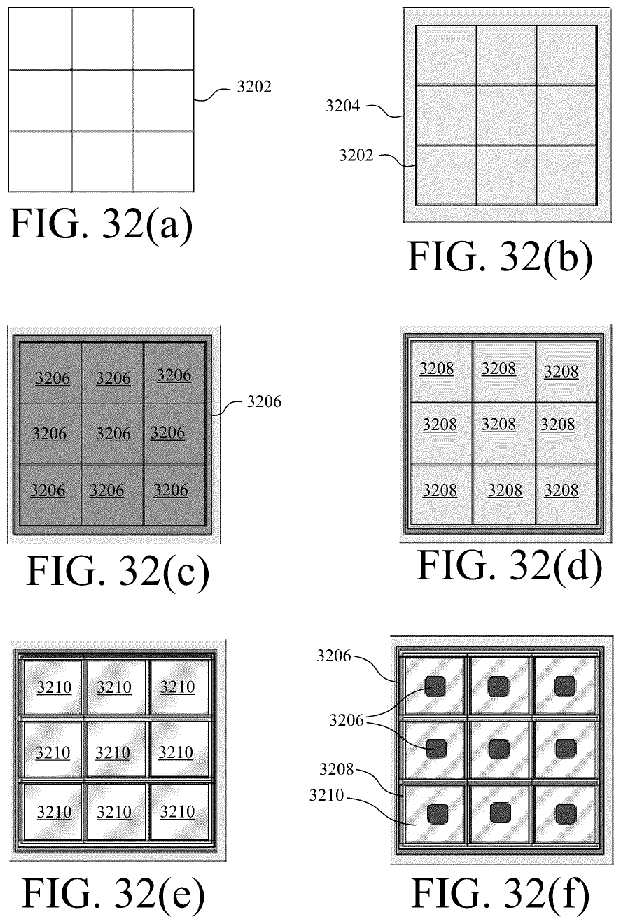

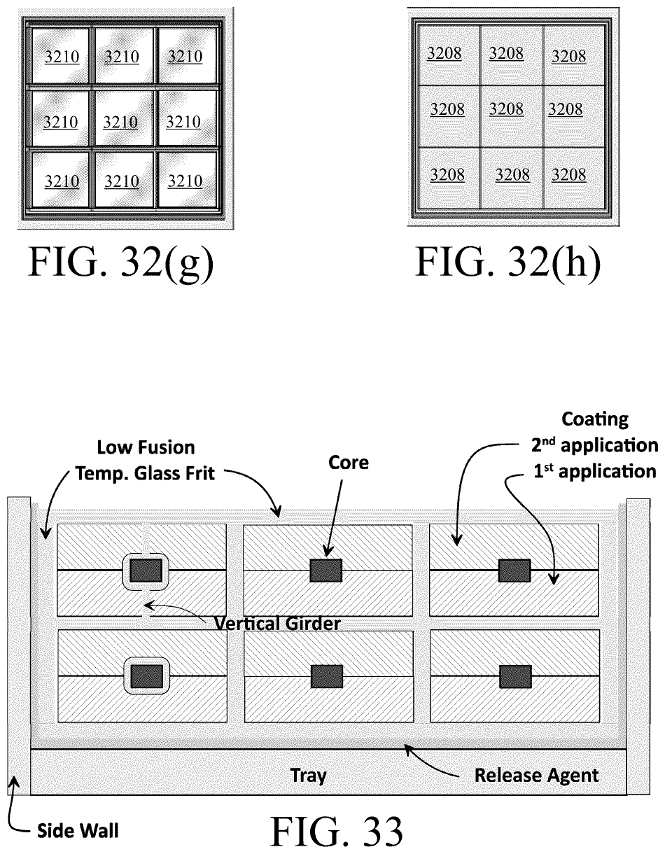

The printing process is presented pictorially step by step in FIGS. 32(a-h). In FIG. 32(a) the computer and printer establish a grid 3202. In (b) the grid 3202 is superimposed over the tray 3204, and in (c) a layer of release agent 3206 is place on the tray. The tray has sidewalls as shown in FIG. 31 to prevent horizontal movement of powders as they are laid down.

In FIG. 32(d) a layer of low fusion temperature glass frit 3208 is placed on top of the release agent except at the edges. Coating material 3210 is printed layer upon layer along with the low fusion temperature glass frit 3208 and release agent 3206, as presented in FIG. 32(e) and FIG. 31. This step may require the printing of many layers of all three materials. All three materials must be laid down simultaneously, or nearly so, as to limit unwanted mixing of the particulate. The cores 3212 are printed along with coating 3210, low fusion glass frit 3208 and release agent 3206 particulates as shown in FIG. 32(f). After the last of the core particulate is printed the laying down of coating 3210, low fusion glass frit 3208, and release agent 3206 particulates resumes. FIG. 32(g) shows a second, top layer of coating material 3210, covering cores 3206. FIG. 32(h) shows a second layer of low fusion glass frit 3208 and release agent 3206, the latter around the edges, laid down after all the coating particulate 3210 has been applied.

After the last application of low fusion temperature glass frit 3208 and release agent 3206, the process of printing seeds repeats/continues as described with reference to FIGS. 32(e) through 32(h).

Adhesive can be included, as needed, with any of the different particulates.

While the drawing in FIG. 31 suggests there are two applications of the coating particulate, it occurs continuously.

Layers of seeds surrounded by release agent in FIG. 31 are initially heated slowly to burn off adhesive, if used in forming seeds, without the escaping gas altering the seed-constructs shown in FIG. 31. After burn-off the temperature is increased to where the low fusion glass frit either sinters or fuses, forming a hard shell surrounding the coating particulate that has experienced some sintering to keep the core particulate in place. The sintering or fusion of the low fusion temperature glass frit forms a continuous block of seeds. The heating temperature is low enough so as not to initiate transformation of the seed into a hollow structure. The heated material is allowed to cool, and the block of seeds is separated from the release agent using pressurized air or similar technique.

Alternatively heating to burn-off adhesive and fuse or sinter the low fusion temperature glass can continue to higher temperatures to transform seeds into a solid block of hollow structures.

FIG. 33 shows, in the two seeds on the left, low fusion temperature glass frit being used to prevent core particulate from dispersing in the coating material. Girders are used in the top left seed to lock the position of the seed's core. If the heat treatment is not sufficient to achieve sufficient sintering of the coating material to keep the core particulate in place, a small layer of low fusion temperature glass frit with adhesive (or without) can be 3D printed around the core as shown in FIG. 33 to keep the core particulate from dispersing in the coating material. In the same figure low fusion glass frit upon heat treatment is used to both lock the position of the seed's core and prevent core particulate from dispersing in the coating material. On the left side, in FIG. 33, low fusion temperature glass frit surrounds the core and is used to form girders of the glass to extend to the outer shell of low fusion temperature glass frit. These additions of glass frit will likely include adhesive. The locations of the girders in FIG. 33 are not to be considered as limiting.

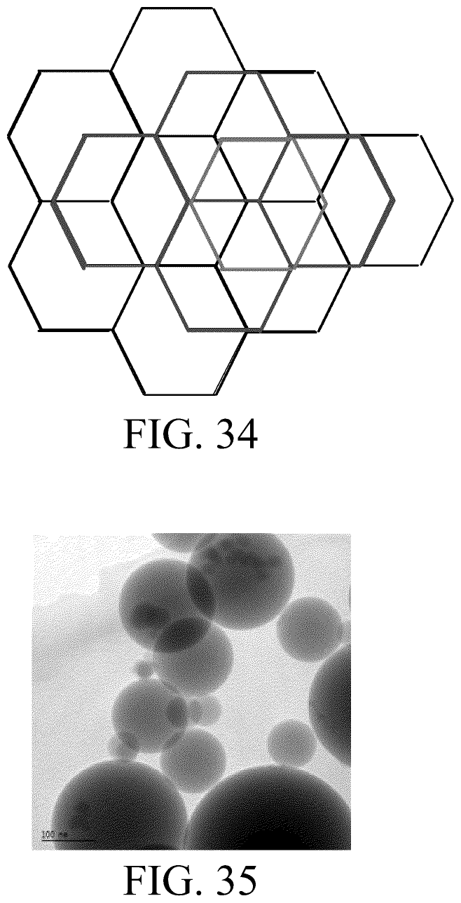

Layers of seed can be stacked in any pattern. In FIG. 31 the rectangular seeds are stacked in offset horizontal layers, whereas the layers are not offset in FIG. 33. The cross-sectional shape of the seeds as viewed from above, as in FIG. 32, is not limited to squares. The seeds can be 3D printed in rectangles, trapezoid, triangle, and hexagonal shapes (again as viewed from above) and stacked in offsetting order as presented in FIG. 34. Any interlocking shape can be used with computer 3D printing of the seeds. The variation in shape of the seeds can also be applied to cross-sectional views from the side.

### Description of Methods for Preparing Particulate for 3D Printing

There are at least seven options for preparing or selecting silica for coating seed cores by application of 3D printing. They include, but are not necessarily limited to, the following.

### 1. Silica Fume

Silica fume, also known as microsilica, is an amorphous (non-crystalline) polymorph of silicon dioxide. It is an ultrafine powder collected as a by-product of silicon and ferrosilicon production and consists of spherical particles (as shown in FIG. 35) with an average particle diameter of 150 nm (0.15 micron). Producers of silicon and ferrosilicon often operate their submerged arc furnaces with a high top-bed temperature and with less carbon to allow SiO(g) to escape the bed and be oxidized by oxygen in air, producing silica fume. The grade and cost of the silica fume is judged by both its impurity content and particle size. The higher of both factors, the lower the cost of the fume. Note that Silica fume and fumed silica are different. The latter is formed by reacting SiCl₄ with H₂O producing SiO₂ and HCl.

### 2. Comminution and Attrition Scrubbing

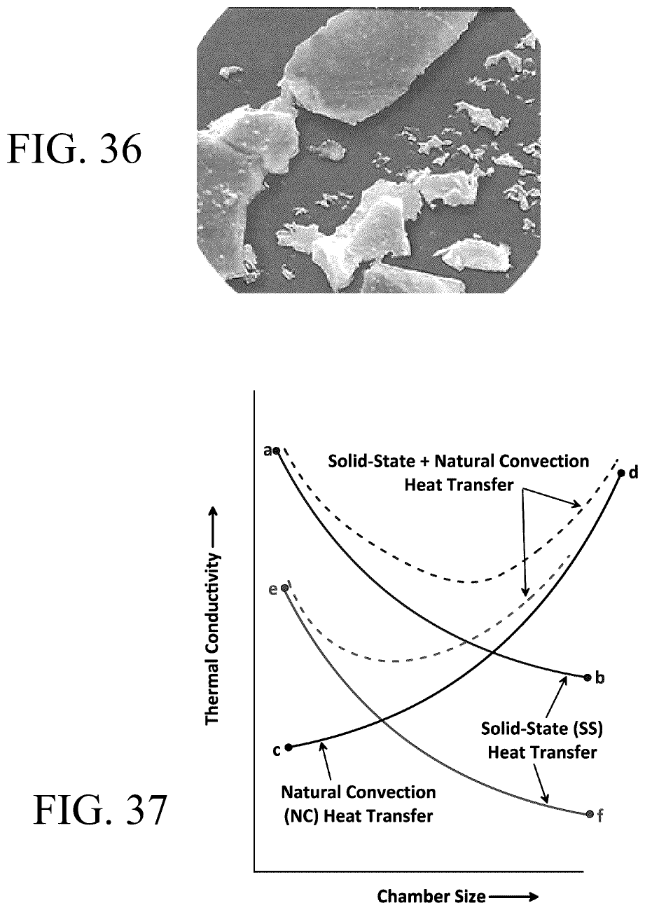

Comminution can be used to produce particulate ranging in size from 1 to 10 micron. That particulate will have sharp edges as shown in FIG. 36 and will pose a problem as the irregular shape of the particulate can lead to clogging of printer heads. The sharp points on the particulate can be eliminated through attrition scrubbing, producing more spherical particulate.

3. Silica Fume Production without the Silicon Submerged Arc Furnace

Silicon and silica can be heated without coke or coal to produce SiO(g) by reaction 16. Oxidation of SiO(g) with air produces silica fume. The product of this process would look like that presented in FIG. 35.

### 4. Flame Polishing

Heating the particulate to a high temperature, where the viscosity of the silica cannot overcome the physical drive to reduce surface energy associated with sharp points. The heating produces more rounded particulate.

### 5. Fusion of Silica

Heating the particulate to a high temperature, where the viscosity of the silica cannot overcome the physical drive to reduce the surface energy of the entire particle by reforming it as a sphere.

### 6. Alluvial and Marine Terrace Deposits

Glacial, river, and ocean tide activity produces fine grain silica. That material tends to have particulate in a rough to near spherical shape.

### 7. Waste Product

A waste product of the appropriate size may be available and only require attrition scrubbing to be used in 3D printing.

In many instances HMS will be formed with silica with a high degree of impurity content. That impurity content can specifically impact Options 4 and 5 by lowering required temperatures.

### Description of Process for Forming VacuBoards and HollowBoards

A VacuBoard is formed by transforming the continuous block of seeds produced with the Grid Surface Technique (GST) into a continuous block of hollow structures with an internal pressure below 0.001 atm requiring more than 1000 years for the internal pressure of the hollow structures to increase to 0.01 atm in the presence of air at 300° C. That requirement applies to the internal hollow structures and does not apply to the thin layer of hollow structures that form the exterior surface of the VacuBoard.

With some gases used in transformation, the seeds in contact with the exterior environment may act as an additional diffusion barrier to the external environment, and, therefore, prevent exterior gases from penetrating the interior of the VacuBoard. The exterior seeds may not undergo any transformation, forming a skin surrounding the VacuBoard.

Boards not meeting the requirements for VacuBoards are referred to as HollowBoards.

FIG. 37 illustrates heat transfer mechanisms of hollow structures. Curve a-b represents heat transfer through the walls of the hollow structures. Curve c-d represents heat transfer by natural convection of the gas. Curve e-f represents heat transfer with thinner walls, compared to line a-b. The dashed lines reflect the combined heat transfer of solid state and natural convection.

The impact of the internal pressure on the thermal conductivity is presented in FIG. 37. Thermal conductivity of gas filled hollow cells involves heat moving down a temperature gradient in the walls, walls that form chambers that encapsulate the gas. The walls heat the gas creating natural convection. The extent of heat transfer with natural convection increases with the size of the chamber as there is a greater temperature drop between the hottest and coolest portion of the chamber. It is that temperature difference that drives the natural circulation and the movement of energy with hot gas rising and cold gas sinking.

The impact of the two methods of heat transfer in gas-filled hollow structures is represented in FIG. 37. The sum of heat transfer by solid-state and natural convection (the dashed lines in FIG. 37) produces a minimum value for the thermal conductivity as heat transferred by natural convection increases with chamber size, while having the opposite impact on solid-state heat transfer. With smaller chamber size there are more walls per unit volume. The combined impact on heat transfer can be reduced by decreasing the wall thickness as represented by the difference in solid-state line a-b representing a wider wall thickness than that represented by the line e-f. Decreasing the wall width, while reducing the thermal conductivity, unfortunately reduces mechanical strength.

The thermal conductivity for HollowBoards is represented by the dashed lines in FIG. 37.

Heat transfer in rigid hollow structures, with near perfect internal vacuum and no open porosity, eliminates natural convection. Thus, for VacuBoards line c-d in FIG. 37 is eliminated and thermal conductivity of VacuBoards is represented by lines a-b or e-f depending on the wall thickness of the structures.

The extent of radiant heat transfer increases with temperature and chamber size. The general characteristics presented in FIG. 37 apply to home heating and cooling. At higher temperatures radiant heat transfer dominates.

Natural convection is eliminated by eliminating gas within the sealed hollow structures. This can be accomplished with two chemical systems. Details are presented in Table I. After forming a hollow structure, and upon cooling, decomposition of SiO(g) produces a fine powder mixture of elemental silicon and silica. If CO(g) is present the size of the Si grains produced with the decomposition of SiO(g) is important and can be controlled; rapid cooling to a temperature near 800° C. will produce a small grain size. With the small silicon grains there is a high surface area available for reaction with CO(g), which produces SiC and more silica. For both chemical systems presented in Table I it is possible to achieve an internal pressure below 10⁻³ bar.

Two methods are presented for transforming the block of seeds produced with the GST into Vacuboards. The processes are based on reactions 15 and 16. The SiO₂ in those reactions is present as either a pure phase or combined with Si (reaction 16) or SiC (reaction 15). Alternatively, the SiO₂ can be the silica in the glass coating material. The latter will require, to achieve the desired internal pressure, a higher operational temperature due to the reduced activity of the silica.

During transformation of the seeds into hollow spheres the block of seeds produced with GST is placed in a mold that confines horizontal growth while allowing for vertical growth (this arrangement can be switched). During the transformation process the seeds begin to transform filling the available space. Since horizontal space is limited, once the horizontal space is fully occupied the transformation involves the growth of the hollow structures in the vertical direction.

Uniform growth of the hollow structures requires uniform heat transfer. Two methods are presented by way of example. However, this list of methods is not exhaustive and should not be considered as limiting.
1. During heating lack of uniform heat transfer can produce lack of uniformity in the hollow structures in a VacuBoard.
2. An alternative is to heat the block of seeds to a temperature below the transformation temperature at an exterior pressure of 1 bar, and then decrease the pressure to a value where the pressure created by the transformation reaction exceeds the exterior pressure. It is faster to establish a uniform exterior pressure than it is to have uniform temperature and therefore uniform heat transfer.

While there may be some irregular rate of growth between the hollow structures, the growth will tend to self-regulate as both transformation reactions (reactions 15 and 16) are endothermic. The faster a hollow structure grows the cooler the core of the seed becomes, thus slowing the rate of transformation.

### Description of Methods for Minimizing the Impact of the Hydrostatic Head

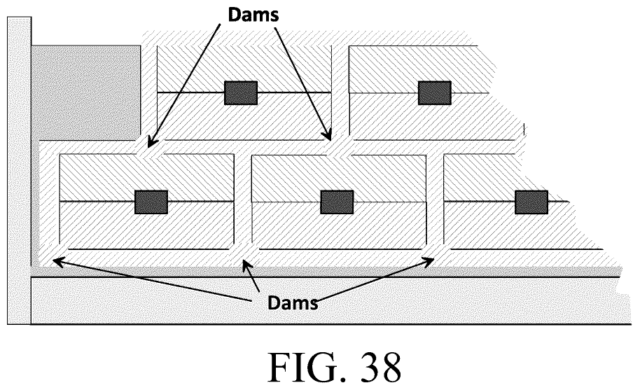

During the transformation process, the low fusion temperature glass's viscosity can become low enough for the glass to flow. During the final transformation heating the low fusion glass interacts with the coating particulate, which has a higher silica content, dissolving some of the coating particulate. The addition of the coating particulate to the low fusion temperature glass increases its viscosity, decreasing its ability to flow. If that increase in viscosity is not sufficient in reducing the flow of the low fusion temperature glass, dams consisting of the coating particulate can be added, as shown in FIG. 38, to physically limit its flow and allow for more time for more high silica coating particulate to dissolve in the low fusion temperature glass.

### NON-LIMITING EXEMPLARY EMBODIMENTS (EES)

EE 1. A method for producing a seed capable of transforming into a hollow structure, the method including:
   a. providing a core having a particular composition that when heated reacts to generate a gas or reacts with the coating to generate a gas;
   b. forming a coating around the core, the coating having a particular composition that when heated will fuse to form a continuous shell surrounding the core;
   c. forming an external layer of low fusion temperature material surrounding the coating;
   d. forming a layer of release agent surrounding the external layer of low fusion temperature material in EE 1.c.; and
   e. upon heating the construct formed in EEs 1a. through 1.d. the low fusion temperature material applied in EE 1.c. either sinters or fuses at a temperature, below that of the fusion temperature of the coating and below that temperature where the core in EE 1.a. produces a gas that is capable of transforming the seed into a hollow structure, forming a fixed shell around the coating, and
   f. where all materials (core, coating, low fusion temperature material, and release agent) are laid in place by 3-dimentional printing or inkjet like printing, or similar means and
   g. the seed with the fixed shell in 1.e. is recovered by sieving and slight milling or other similar means.
EE 2. The method in EE 1 can be repeated producing multiple seeds in a single layer separated by release agent prior to heating.
EE 3. The methods in EEs 1 and 2 can be repeated, prior to heating, producing multiple layers of seeds separated by release agent.
EE 4. The seeds produced in EEs 1 through 3 are heated to a temperature where the low fusion temperature material either sinters or fuses forming a fixed shell around the core and the coating material without the core in EE 1.a. producing a gas that is capable of transforming the seed into a hollow structure.
EE 5. Individual seeds produced in EE 4 can be recovered by sieving and slight milling or similar means.
EE 6. A method for producing a seed capable of transforming into a hollow structure, the method including:
   a. providing a core having a particular composition that when heated reacts to generate a gas or reacts with the coating to generate a gas;
   b. forming a layer of low fusion temperature material around the core, the low fusion temperature material having a particular composition that when heated will sinter or fuse to form a continuous shell surrounding the core preventing core material from mixing with coating material;
   c. forming a coating around the core with the surrounding layer of low fusion temperature material, the coating having a particular composition that when heated will fuse to form a continuous shell surrounding the core with a surrounding layer of low fusion temperature material, with the coating material having a higher sintering and fusion temperature than that of the low fusion temperature material;
   d. forming an external layer of low fusion temperature material surrounding the coating; and
   e. forming a layer of release agent surrounding the external layer of low fusion temperature material applied in EE 6.d., and
   f. where all materials (core, coating, and release agent) are laid in place by 3-dimensional printing or inkjet like printing, or similar means.
EE 7. The method in EE 6 can be repeated producing multiple seeds in a single layer separated by release agent prior to heating.
EE 8. The methods in EEs 6 and 7 can be, prior to heating, repeated producing multiple layers of seeds separated by release agent.
EE 9. The seeds produced in EEs 6 through 8 are heated to a temperature where the low fusion temperature material either sinters or fuses forming a fixed shell around the core and the coating material without the core in EE 6.a. producing a gas that is capable of transforming the seed into a hollow structure.
EE 10. Individual seeds produced in EEs 6 through 9 can be recovered by sieving and slight milling or similar means.
EE 11. A method for producing a seed capable of transforming into a hollow structure, the method including:
   a. providing a core having a particular composition that when heated reacts to generate a gas or reacts with the coating to generate a gas;
   b. forming a layer of low fusion temperature material around the core, the low fusion temperature material having a particular composition that when heated will sinter or fuse to form a continuous shell surrounding the core preventing core material from mixing with coating material;
   c. forming a coating around the core with the surrounding layer of low fusion temperature material, the coating having a particular composition that when heated will fuse to form a continuous shell surrounding the core with a surrounding layer of low fusion temperature material, with the coating material having a higher sintering and fusion temperature than that of the low fusion temperature material;
   d. in applying the coating, girders of the low fusion temperature material are laid down extending from the core coated with the low fusion temperature material to the exterior of the coating;
   e. forming an external layer of low fusion temperature material surrounding the coating that also connects the low fusion temperature material surrounding the core through the girders applied in EE 11.d.; and
   f. forming a layer of release agent surrounding the external layer of low fusion temperature material applied in EE 11.e.; and
   g. where all materials (core, coating, and release agent) are laid in place by 3-dimentional printing or inkjet like printing, or similar means.
EE 12. The method in EE 11 can be repeated producing multiple seeds in a single layer separated by release agent prior to heating.
EE 13. The methods in EEs 11 and 12 can be repeated producing multiple layers of seeds separated by release agent prior to heating.
EE 14. The seeds produced in EEs 12 and 13 are heated to a temperature where the low fusion temperature material either sinters or fuses forming fixed girders that connect the fixed low fusion temperature material surrounding the core; and the coating, with the girders keeping the core in the middle of the coating and forming a fixed shell around the core and the coating without the core in EE 11.a. producing a gas that is capable of transforming the seed into a hollow structure.
EE 15. Individual seeds produced in EEs 11 through 14 can be recovered by sieving and slight milling or similar means.
EE 16. A method for producing blocks of seeds capable of transforming into honeycomb like structures, the method includes:
   a. providing a core having a particular composition that when heated reacts to generate a gas or reacts with the coating to generate a gas;
   b. forming a coating around the core, the coating having a particular composition that when heated will fuse to form a continuous shell surrounding the core; and
   c. forming a layer of external low fusion temperature material surrounding the coating.
EE 17. The method in EE 16 can be repeated producing multiple seeds in a single layer separated by the low fusion temperature material.
EE 18. The methods in EEs 16 and 17 can be repeated producing multiple layers of seeds that represent a block of seeds, where the individual seeds are separated by a layer of the low fusion temperature material.
EE 19. The block of seeds is produced in a confined space, the space resembling a box without a top, and the block of seeds covered on the sides and bottom by release agent.
EE 20. All materials (core, coating, low fusion temperature material, and release agent) are laid in place by 3-dimentional printing or inkjet like printing, or similar means.
EE 21. The block of seeds in EE 19 is heated to a temperature where the low fusion material either sinters or fuses, a temperature where the coating may partially sinter without the core in EE 16.a. producing a gas that is capable of transforming the seed into a hollow structure, while forming cores covered in coating material and sealed in a matrix of the low fusion temperature material.
EE 22. The release agent applied identified in EE 19 and after heating can be removed by pressurized air or by brushing or by similar means.
EE 23. A method for producing blocks of seeds capable of transforming into honeycomb like structures, the method includes:
   a. providing a core having a particular composition that when heated reacts to generate a gas or reacts with the coating to generate a gas; and
   b. forming a layer of low fusion temperature material around the core, the low fusion temperature material having a particular composition that when heated will sinter or fuse to form a continuous shell surrounding the core preventing core material from mixing with coating material, and
   c. forming a coating around the core with a surrounding layer of low fusion temperature material, the coating having a particular composition that when heated will fuse to form a continuous shell surrounding the core, and
   d. with a surrounding layer of low fusion temperature material surrounding the coating, with the coating having a higher sintering and fusion temperature than that of the low fusion temperature material.
EE 24. The method in EE 23 can be repeated producing multiple seeds in a single layer separated by the low fusion temperature material.
EE 25. The methods in EEs 23 and 24 can be repeated producing multiple layers of seeds that represent a block of seeds, where the individual seeds are separated by a layer of the low fusion temperature material.
EE 26. The block of seeds is produced in a confined space, the space resembling a box without a top, and the block of seeds covered on the sides and bottom by release agent.
EE 27. All materials (core, coating, low fusion temperature material, and release agent) are laid in place by 3-dimentional printing or inkjet like printing, or similar means.
EE 28. The block of seeds is heated to a temperature where the low fusion material either sinters or fuses, a temperature where the coating may partially sinter without the core in
EE 23.a. producing a gas that is capable of transforming the seed into a hollow structure, while forming cores covered in a layer of the low fusion temperature material surrounded by coating material and sealed in a matrix of the low fusion temperature material.
EE 29. The release agent in EE 26 and after heat treatment can be removed by pressurized air or by brushing or by similar means.
EE 30. A method for producing blocks of seeds capable of transforming into honeycomb like structures, the method includes:
   a. providing a core having a particular composition that when heated reacts to generate a gas or reacts with the coating to generate a gas;
   b. forming a layer of low fusion temperature material around the core, the low fusion temperature material having a particular composition that when heated will sinter or fuse to form a continuous shell surrounding the core preventing core material from mixing with coating material;
   c. forming a coating around the core with the surrounding layer of low fusion temperature material, the coating having a particular composition that when heated will fuse to form a continuous shell surrounding the core;
   d. in applying the coating in EE 30.c., girders of the low fusion temperature material are laid down extending from the core coated with the low fusion temperature material to the exterior of the coating;
   e. the low fusion temperature material forming an external layer surrounding the coating that also connects the low fusion temperature material surrounding the core through the girders applied in EE 30.d.; and
   f. with the coating having a higher sintering and fusion temperature than that of the low fusion temperature material.
EE 31. The method in EE 30 can be repeated producing multiple seeds in a single layer separated by the low fusion temperature material.
EE 32. The methods in EEs 30 and 31 can be repeated producing multiple layers of seeds that represent a block of seeds, where the individual seeds are separated by a layer of the low fusion temperature material.
EE 33. The block of seeds is produced in a confined space, the space resembling a box without a top, and the block of seeds covered on the sides and bottom by release agent.
EE 34. All materials (core, coating, low fusion temperature material, and release agent) are laid in place by 3-dimentional printing or inkjet like printing, or similar means.
EE 35. The block of seeds is heated to a temperature where the low fusion material either sinters or fuses, a temperature where the coating may partially sinter without the core in EE 30.a. producing a gas that is capable of transforming the seed into a hollow structure, while forming cores covered in a layer of the low fusion temperature material surrounded by coating material and sealed in a matrix of the low fusion temperature material.
EE 36. The release agent in EE 33 and after heat treatment can be removed by pressurized air or by brushing or by similar means.
EE 37. The seeds in EEs 1 & 2, EEs 6 & 7, EEs 11 & 12, EEs 16 & 17, EEs 23 & 24, and EEs 30 & 31 can be printed in any shape.
EE 38. The shape of the seeds printed in EEs 16 & 17, EEs 23 & 24, and EEs 30 & 31 can be printed to eliminate open space between the seeds.
EE 39. The shape of the seeds printed in EEs 16 & 17, EEs 23 & 24, and EEs 30 & 31 can be printed to be interlocked to each other.
EE 40. The stacking of seeds in multiple layers in EEs 18, 25, and 32 can be on top of each other or offset in any horizontal direction.
EE 41. A method for producing a seed capable of transforming into a hollow structure, the method including:
   a. providing a core having a particular composition that when heated reacts to generate a gas or reacts with the coating to generate a gas;
   b. forming a coating around the core, the coating having a particular composition that when heated will fuse to form a continuous shell surrounding the core;
   c. the core is injected into a vertical reactor with an electric charge on its surface;
   d. the seeds pass through a cloud of opposite electrically charged droplets of adhesive;
   e. the oppositely charged cores and adhesive drops combined to form a core covered in adhesive, and the charge on the core and adhesive layer remain;
   f. the cores with the adhesive layer pass through a dusty cloud of electrically charged coating particulate where the charge on the coating particulate is opposite that of the adhesive layer covering the core particles;
   g. the charged cores with adhesive combined with the oppositely electrically charged coating particulate, the latter forming a layer around the core with its adhesive covered surface the charge on the core, adhesive, and the coating layer remain; and
   h. the coating covered cores now passes through a cloud of adhesive electrically charged droplets of adhesive where the electrical charge on the droplets of adhesive are opposite that of the coating particulates in EE 41.f.;
   i. the electrically charge droplets of adhesive combine with the oppositely charge coating particulate surrounding the cores before dropping into a vibrated bed of coating powder;
   j. the vibration of the bed is sufficient to cover the adhesive coated material from EE 41.i where additional coating particulate is added to the previous layer of coating material in EE 41g; and
   k. the adhesive in the coated cores from EE 41.j. are allowed to cure before they are recovered by sieving and if necessary slight milling or similar means.
EE 42. The recovered seeds from EE 41.k. can be returned the vertical reactor in EE 41.c. to increase the thickness of the coating layer.
EE 43. The seeds from EE 41.k. are packed in a friable material and heated slowly to burn-off the adhesive before raising the temperature of the seeds in the friable material to a temperature where the coating material surrounding the core sinters or fuses but does not initiate the chemical reaction in the core that will transform the seed into a hollow sphere.
EE 44. The heat-treated seed from EE 43 can be recovered by slight milling and sieving or similar means.
EE 45. The vertical reactor in EE 41.c. can be divided into segments, each segment electrically isolated from the other so that each segment can be electrically charged with the same charge as that on the surface of the materials passing through the segment to prevent unnecessary buildup of material clinging to the wall of the reactor.
EE 46. A method for transforming a seed into a hollow structure whose wall have a high silica content and can be utilized at higher temperatures, the method including:
   a. providing a core having a particular composition that when heated reacts to generate a gas or reacts with the high silica content coating to generate a gas,
      i. the cores composition consisting of silicon either mixed with of alloyed with an element that alloys with silicon upon heating,
      ii. reduces the activity of silicon,
      iii. thereby the reduction in the activity of silicon raises the temperature of the reaction required to produce the gas pressure for transforming a seed into a hollow structure at a pre-determined pressure, and
      iv. the increase in temperature reduces the viscosity of the high silica content coating, and
      v. the elements in EE 46.a.i are those that
         1. have little thermodynamic ability to reduce silica in the formation of SiO(g) as compared to the ability of the chemical reaction between silicon and silica in producing SiO(g),
         2. the elements contribution to the vapor phase is small, and
         3. the elements impact on the viscosity of the coating material is small; and
   b. the materials mixed with or alloyed with silicon in EE 46.a.i. include, but not limited to, are iron and nickel that can upon transforming a seed into a hollow structure form a residue, within the hollow structure, iron rich or nickel rich alloys with silicon can undergo permanent magnetization.
EE 47. A method for transforming a seed into a hollow structure whose walls have a high silica content and can be utilized at higher temperatures, the method including:
   a. providing a core having a particular composition that when heated reacts to generate a gas or reacts with the high silica content coating to generate a gas;
   b. the cores composition consisting of silicon mixed with an element that that forms two phases;
   c. the two phases both reduce and fix the activity of silicon during the production of SiO(g);
   d. the reduction of the activity of silicon, as compared to pure silicon, raises the temperature of the reaction required to produce the gas pressure for transforming a seed into a hollow structure at a pre-determined pressure;
   e. the increase in temperature reduces the viscosity of the high silica content coating; and
   f. the elements in EE 47.a. are those with high fusion temperatures.
48. A method for transforming a seed into a hollow structure whose coating and wall have a high silica content and can be utilized at higher temperatures, the method including:
   a. providing a core having a particular composition that when heated reacts to generate a gas or reacts with the high silica content coating to generate a gas, and
   b. consist of an element that can partially reduce silica in forming SiO(g) and the oxide of the element, and
   c. the oxide of the element dissolves in the high silica content coating and wall, and
   d. the dissolving of the oxide of the element continues the chemical reaction between the element and silica in the production of SiO(g), and
   e. examples of such elements in EE 48.b. are Fe, Ni, and V. (The list is not to be considered as limiting.)
49. Gases that can be used in transferring heat to seeds in their transformation into hollow structures with an internal atmosphere producing, upon cooling to room temperature, an internal pressure of 0.001 atmosphere or smaller include CO(g), H₂O(g), H₂O(g) plus H₂(g).
50. Under some reaction conditions for transforming seed into hollow structures for the gases presented in EE 49 it may be necessary to include additional core material to react with oxidizer diffusing into the hollow structure as it is formed, to achieve the desired pressure of 0.001 atmosphere at room temperature.
51. Dams consisting of coating material can be positioned in the low fusion temperature material applied in EE 16.c., EE 23.d., and EE 30.e. to reduce the hydrostatic pressure, and the flow, of the low temperature material when heated in stacks as described in EE 18, EE 25, and EE 32.

I claim:

1. A method for producing a seed capable of transforming into a hollow structure, said method including:
providing a core having a particular composition that reacts to generate a gas when heated to a first predetermined temperature;
forming a coating around the core to produce a coated core, said coating having a particular composition that will fuse to form a continuous shell surrounding said core when said coating is heated to a second predetermined temperature;
forming an exterior layer of material surrounding said coated core to produce an encased coated core, said material of said exterior layer having a fusion temperature such that said exterior layer of material fuses or sinters below a third predetermined temperature;
forming a layer of release agent surrounding said encased coated core; and
heating said core, said coating, and said exterior layer to a fourth temperature to transform said exterior layer to a fixed shell and produce a seed with said coated core surrounded by said fixed shell, said fourth temperature being greater than or equal to said third predetermined temperature, said fourth temperature being less than said first predetermined temperature, and said fourth temperature being less than said second predetermined temperature.

2. The method of claim 1, wherein said core, said coating, said exterior layer, and said release agent are all positioned relative to one another by a printing process prior to said heating said core, said coating, and said exterior layer to said fourth temperature.

3. The method of claim 1, further comprising mechanically separating said seed from said release agent and other seeds produced with said seed.

4. The method of claim 1, wherein:
said step of providing said core includes providing a plurality of cores arranged in a single layer;
said step of forming a coating around said core includes forming coatings around each core of said plurality of cores to produce a layer of coated cores;
said step of forming an exterior layer of material surrounding said coating includes forming an exterior layer of said material surrounding each coated core of said layer of coated cores to form a layer of encased coated cores; and
said step of forming a layer of release agent surrounding said external layer of material includes forming a layer of release agent separating said encased coated cores from one another.

5. The method of claim 4, further comprising forming multiple layers of encased coated cores separated by release agent prior to heating said core, said coating, and said exterior layer to said fourth temperature.

6. The method of claim 5, wherein said cores of each layer are arranged in a same lattice structure.

7. The method of claim 6, wherein said lattice structure of each layer is offset with respect to said lattice structures adjacent layers.

8. The method of claim 6, wherein said same lattice structure is hexagonal.

9. The method of claim 1, further comprising:
forming an inner layer of said material between said core and said coating; and
forming girders of said material that extend from said inner layer of said material, through said coating, to said exterior layer of said material.

10. The method of claim 1, wherein said step of forming a coating around said core includes:
applying an adhesive to said core; and
bringing said core with said adhesive applied thereon into contact with coating material.

11. The method of claim 10, wherein said step of applying said adhesive to said core includes dropping said core through a cloud of said adhesive.

12. The method of claim 11, wherein said step of bringing said core with said adhesive applied thereon into contact with said coating material includes dropping said core with said adhesive applied thereon through a cloud of said coating material.

13. The method of claim 12, wherein said step of dropping said core through said cloud of said adhesive includes:
applying a positive electrical charge to one of said core and said adhesive; and
applying a negative electrical charge to the other of said core and said adhesive.

14. The method of claim 13, wherein said step of dropping said core with said adhesive applied thereon through a cloud of said coating material includes:
applying a positive electrical charge to one of said adhesive and said coating material; and
applying a negative electrical charge to the other of said adhesive and said coating material.

15. The method of claim 1, wherein said core includes silicon alloyed with an element that reduces the activity of silicon.

16. The method of claim 1, wherein said core includes silicon mixed with an element that alloys with silicon upon heating and reduces the activity of silicon.

17. The method of claim 1, wherein said core includes:
silicon; and
at least one of iron and nickel.

18. A method for forming seeds in a tray, said seeds capable of transforming into hollow structures:
providing a tray having a bottom surface;
depositing a first layer of release agent on said bottom surface of said tray;
depositing a first layer of outer shell material on said layer of release agent, said first layer of said outer shell material being patterned in an array of discrete spaced apart shapes;
depositing a first layer of coating material on said first layer of outer shell material, said first layer of coating material being patterned in an array of discrete spaced apart shapes, each of said discrete spaced apart shapes of said coating material being disposed on an associated one of said discrete spaced apart shapes of said outer shell material;
depositing a layer of seed material on said first layer of said coating material, said layer of seed material being patterned in an array of discrete spaced apart shapes, each of said discrete spaced apart shapes of said seed material being disposed on an associated one of said discrete spaced apart shapes of said coating material;
depositing a second layer of coating material over said first layer of coating material and over said seed material, said second layer of coating material being patterned in an array of discrete spaced apart shapes, each said discrete spaced apart shape of said second layer of coating material contacting an associated one of said discrete spaced apart shapes of said first layer of coating material with an associated one of said discrete spaced apart shapes of said seed material disposed therebetween;
depositing a second layer of said outer shell material over said second layer of said core material, said second layer of said core material being patterned in an array of discrete spaced apart shapes, each discrete spaced apart shape of said second layer of said core material overlying an associated one of said discrete spaced apart shapes of said second layer of said coating material and being in contact with said first layer of said outer shell material; and
depositing a second layer of said release agent over said second layer of outer shell material, said second layer of said release agent being in contact with said first layer of said release agent between said discrete spaced apart shapes of said first layer of said outer shell material.

19. The method of claim 18, wherein said first layer of said outer shell material, said first layer of said coating material, said layer of core material, said second layer of said coating material, and said second layer of said outer shell material are deposited simultaneously via a 3-dimensional printing process.

20. The method of claim 18, wherein:
said core material has a particular composition that reacts to generate a gas when heated to a first predetermined temperature;
said coating material has a particular composition that will fuse to form a shell around said core when said coating material is heated to a second predetermined temperature;
said outer shell material has a fusion temperature such that said outer shell material will fuse or sinter below a third predetermined temperature;
a fourth temperature is less than said first predetermined temperature;
said fourth temperature is less than said second predetermined temperature; and
said fourth temperature is greater than or equal to said third predetermined temperature; and further comprising
heating said first layer of said outer shell material, said first layer of said coating material, said layer of core material, said second layer of said coating material, and said second layer of said outer shell material to said fourth temperature.
